(19) United States
(12) Patent Application Publication
(10) Pub. No.: US 2008/0018546 A1
(43) Pub. Date: Jan. 24, 2008

(54) Antenna Apparatus

(75) Inventors: Tomoya Nakanishi, Osaka (JP); Hiroyuki Uno, Ishikawa (JP); Yutaka Saito, Ishikawa (JP)

Correspondence Address: STEVENS, DAVIS, MILLER & MOSHER, LLP, 1615 L. STREET N.W., SUITE 850, WASHINGTON, DC, 20036, US

(73) Assignee: Matsushita Electric Industrial Co., Ltd., Osaka (JP)

(21) Appl. No.: 11/630,379

(22) PCT Filed: Nov. 28, 2005
(86) PCT No.: PCT/JP05/21802

§ 371 Date: Dec. 22, 2006

(30) Foreign Application Priority Data
Nov. 30, 2004 (JP) 2004-345379

(51) Int. Cl. H01Q 11/06

(52) U.S. Cl. 343/733

(57) ABSTRACT

An antenna apparatus capable of main beam direction switching is provided that achieves high gain with a small, planar configuration. Rhombic antenna sections composed of linear elements 101a through 101d, 102a through 102d, and 103a through 103d are arranged in the same plane, and the rhombic antenna sections are connected by linear linking elements 104a through 104d. Linear detour elements 105a and 105b are connected to the pair of vertices of the rhombic antenna sections arranged at each end. Feed points 106a and 106b are provided at the other opposite two pairs of vertices of any of the rhombic antenna sections, and the opposite vertices of the other rhombic antenna sections are connected by linear elements. A plate reflector is arranged at a distance h from, and parallel to, the surface on which the rhombic antenna elements are arranged.

### TECHNICAL FIELD

The present invention relates to a small planar antenna apparatus capable of main beam direction switching, and is suitable for use as a high speed radio communication antenna in, for example, road-to-vehicle communication or vehicle-to-vehicle communication.

### BACKGROUND ART

In recent years, road-to-vehicle communication systems and vehicle-to-vehicle communication systems using 25 GHz band, 60 GHz band, and so forth, have been studied. In these communication systems, since the antenna apparatus installed in a vehicle is positioned comparatively close to the road (inside a bumper, for example), there is a problem that reflection from the road cannot be ignored and transmission quality degrades due to fading. Therefore, the antenna apparatus installed in a vehicle needs to have narrow directivity to the vertical direction with respect to the road, and to have a small configuration. It is also preferable that the antenna apparatus has high gain in order to extend the communication distance, and can switch the beam direction within the horizontal plane according to the course of the road since a road is assumed to curve as well as to run in a straight line.

Up to now, a planar patch array antenna has been known as an antenna for achieving high gain with a small, planar configuration. This antenna narrows beam directivity in the main radiation direction and achieves high gain by having a plurality of antenna elements arranged within a plane perpendicular to the main radiation direction and performing distribution feeding (see Patent Document 1, for example.)

Also, a patch Yagi-Uda array antenna has been proposed as an antenna capable of switching beam (see Patent Document 2, for example). FIG. 20 is a drawing showing the configuration of a patch Yagi-Uda array antenna described in Patent Document 2. This antenna is configured with feed elements 2001a through 2001d, passive element 2002, and passive element groups 2003a through 2003d, and achieves small antenna apparatus size by sharing the wave directors (passive elements) that account for the major part of a Yagi-Uda array antenna. By switching power feeding to feed elements 2001a through 2001d, it is possible to switch beam in four directions with the antenna apparatus shown in this figure.

A detour element loaded loop antenna has been proposed as another beam switching antenna (see Non-Patent Document 1, for example.) FIG. 21 is a drawing showing the configuration of the detour element loaded loop antenna described in Non-Patent Document 1. As shown in the figure, linear elements 2101a through 2101d are arranged in a rhombic shape, linear detour element 2102a is connected between linear elements 2101a and 2101c, and linear detour element 2102b is connected between linear elements 2101b and 2101d. Feed point 2103a is provided between linear elements 2101a and 2101b, and feed point 2103b is provided between linear elements 2101c and 2101d. Plate reflector 2104 is arranged parallel to the antenna elements configured as described above. By configuring an antenna apparatus in this way, and switching between feed points 2103a and 2103b, it is possible to switch the main beam in two directions. By this means, it is possible to switch beam with a planar, small configuration.

Patent Document 1: Japanese Patent Application Laid-Open No. HEI6-334434

Patent Document 2: Japanese Patent Application Laid-Open No. 2003-142919 Non-Patent Document 1: Technical report A-P2003-157 of The Institute of Electronics, Information and Communication Engineers, November 2003

### DISCLOSURE OF INVENTION

### Problems to be Solved by the Invention

However, the planar patch array antenna described in Patent Document 1 has a problem that, since the main beam direction cannot be switched, transmission quality degrades significantly depending on the vehicle driving condition. Another problem is that the influence of feed loss increases because of the array configuration using distribution feeding.

Also, the patch Yagi-Uda array antenna described in Patent Document 2 has a problem that it is necessary to increase the number of elements in order to achieve higher gain, thereby resulting in a larger antenna size.

Furthermore, the detour element loaded loop antenna described in Non-Patent Document 1 has a problem that, since the beam width is large, reflection is easily received from the road surface. Thus, it is necessary to further narrow directivity.

The present invention has been made taking into account the problems described above, and it is therefore an object of the present invention to provide an antenna apparatus that achieves high gain with a small, planar configuration and capable of main beam direction switching.

### Means for Solving the Problems

In order to solve the above described problems with the prior art, an antenna apparatus of the present invention has the features described below. Firstly, an antenna apparatus adopts a configuration having a plurality of rhombic antenna sections in which four linear elements having lengths of approximately ¼ of the wavelength to approximately ⅜ of the wavelength of the used frequency are arranged in a rhombic shape in the same plane, and of the four linear elements, a first linear element and second linear element are connected, and a third linear element and fourth linear element are connected, wherein the plurality of rhombic antenna sections are connected by a linear linking element having a predetermined length, a folded-back linear detour element having a predetermined full length is connected to each end of the linked plurality of rhombic antenna sections, and a plate reflector is arranged at a predetermined distance from the plane in which the plurality of rhombic elements are arranged, and approximately parallel to the plane, the antenna apparatus having a first feed point that feeds power to the junction of the first linear element and second linear element of the plurality of rhombic antenna sections, a second feed point that feeds power to a junction of the third linear element and fourth linear element, and a switching section that switches selectively between the first feed point and second feed point.

According to this configuration, it is possible to achieve high gain with a small, planar antenna apparatus. Also, by switching selectively between the first feed point and second feed point, it is possible to switch the main beam in two directions. Furthermore, it is possible to vary the angle of the main beam in the horizontal direction.

### ADVANTAGEOUS EFFECT OF THE INVENTION

As described above, an antenna apparatus of the present invention can achieve high gain and switch the main beam in two directions with a small, planar configuration. In addition, it is possible to switch the angle of the main beam in the horizontal direction.

### BRIEF DESCRIPTION OF DRAWINGS

FIG. 1 is a configuration diagram of an antenna apparatus according to Embodiment 1 of the present invention;

FIG. 2 is a drawing showing current amplitude and current phase of an antenna apparatus according to Embodiment 1 of the present invention;

FIG. 3 is a drawing showing the directivity of an antenna apparatus according to Embodiment 1 of the present invention;

FIG. 4 is a drawing showing the F/B ratio and directional gain when the linear linking element length is varied;

FIG. 5 is a configuration diagram in which feed points are provided in a rhombic antenna section on the +Y side in an antenna apparatus according to Embodiment 2 of the present invention;

FIG. 6 is a drawing showing the directivity when feed points are provided in a rhombic antenna section on the +Y side;

FIG. 7 is a configuration diagram in which feed points are provided in a rhombic antenna section on the −Y side in an antenna apparatus according to Embodiment 2 of the present invention;

FIG. 8 is a drawing showing the directivity when feed points are provided in a rhombic antenna section on the −Y side;

FIG. 9 is a configuration diagram of an antenna apparatus according to Embodiment 3 of the present invention;

FIG. 10 is a flowchart showing switching operation of feed points of an antenna apparatus according to Embodiment 3 of the present invention;

FIG. 11 is a configuration diagram of an antenna apparatus according to Embodiment 4 of the present invention;

FIG. 12 is a planar view from the −Z side of an antenna apparatus according to Embodiment 4 of the present invention;

FIG. 13 is a drawing showing the directivity of an antenna apparatus according to Embodiment 4 of the present invention;

FIG. 14 is a planar view from the +Z side of an antenna apparatus according to Embodiment 5 of the present invention;

FIG. 15 is a planar view from the −Z side of an antenna apparatus according to Embodiment 5 of the present invention;

FIG. 16 is a flowchart showing switching operation of feed points of an antenna apparatus according to Embodiment 5 of the present invention;

FIG. 17 is a configuration diagram of an antenna apparatus according to Embodiment 6 of the present invention;

FIG. 18 is a planar view from the −Z side of an antenna apparatus according to Embodiment 6 of the present invention;

FIG. 19 is a drawing showing the directivity of an antenna apparatus according to Embodiment 6 of the present invention;

FIG. 20 is a configuration diagram of a patch Yagi-Uda array antenna shown in Patent Document 2; and

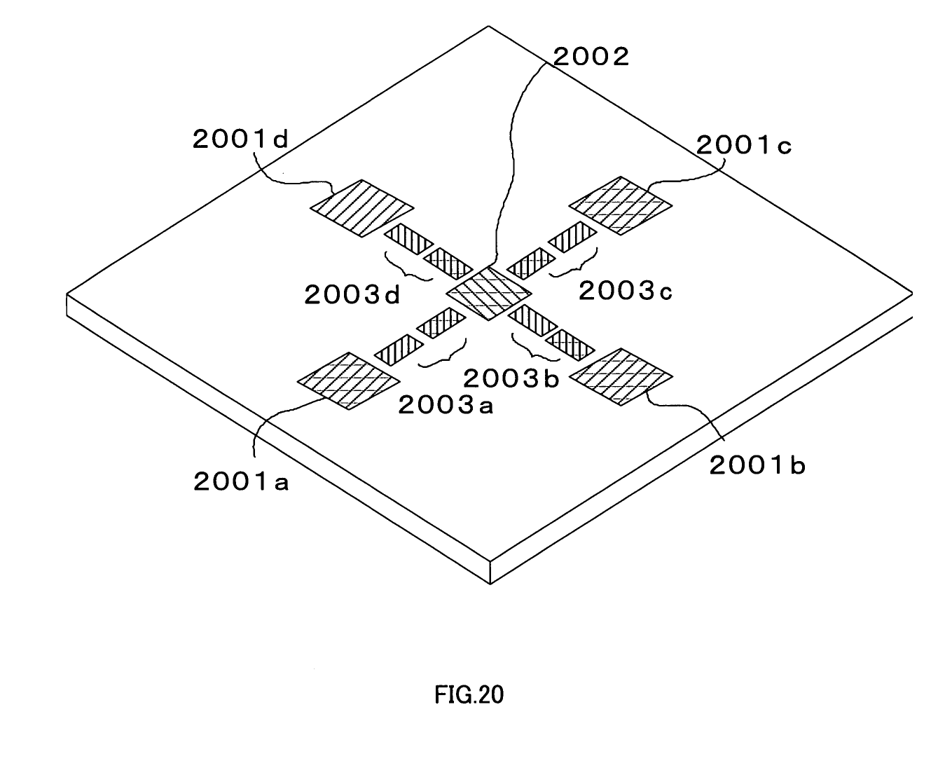

FIG. 21 is a configuration diagram of a detour element loaded loop antenna described in Non-Patent Document 1.

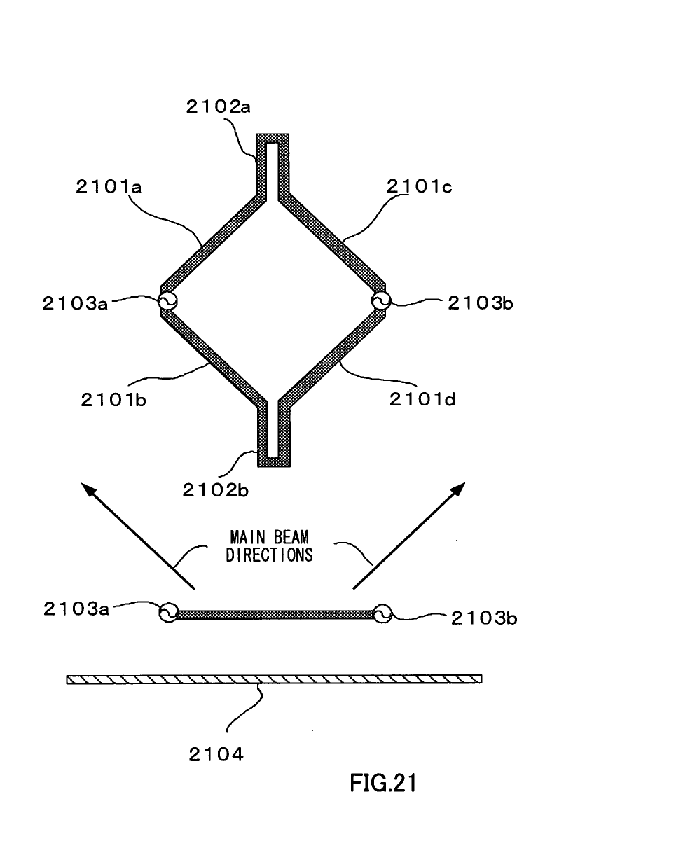

### BEST MODE FOR CARRYING OUT THE INVENTION

Antenna apparatuses of embodiments of the present invention will now be described in detail with reference to the accompanying drawings.

### Embodiment 1

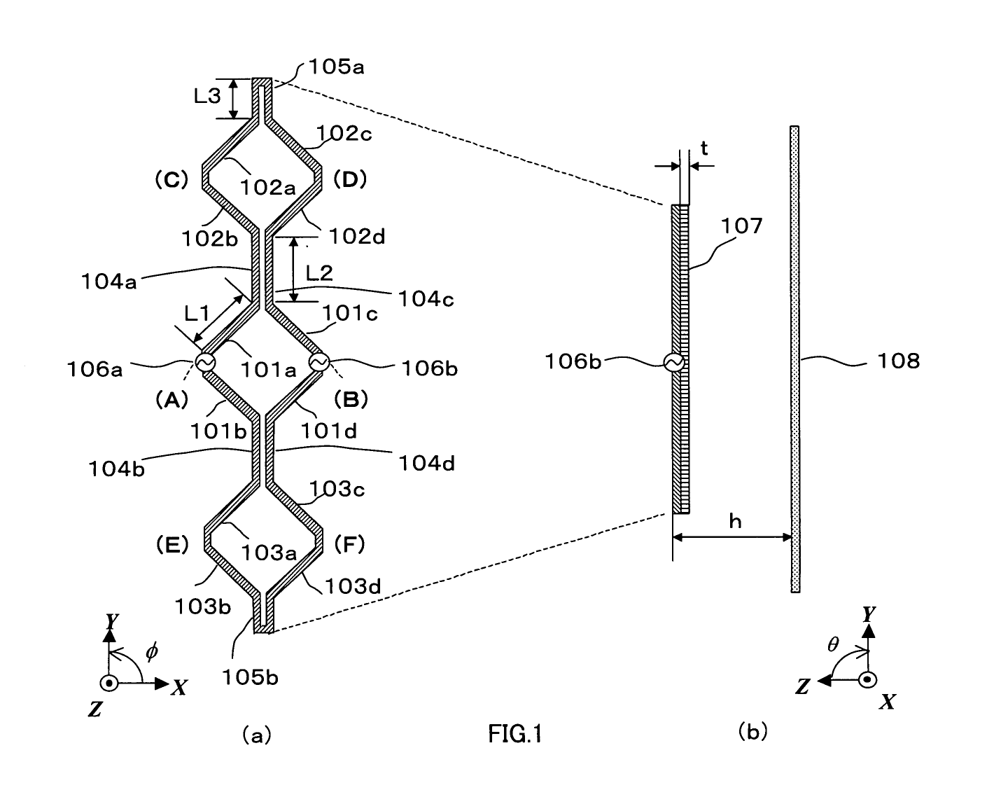

FIG. 1 is a drawing showing the configuration of an antenna apparatus according to Embodiment 1 of the present invention. Below, a case will be described in which an antenna is created on a dielectric substrate of, for example, ∈r=2.26, assuming that its operating frequency is 25 GHz and one wavelength (one effective wavelength) is 8.6 mm. The coordinate axes shown in FIG. 1 are defined for convenience of explanation.

FIG. 1(a) is a planar view showing the configuration of an antenna apparatus according to Embodiment 1 of the present invention. In this figure, linear elements 101a through 101d, 102a through 102d, and 103a through 103d are electrical conductors with element length L1 of approximately ⅓ wavelength (2.8 mm), and an element width of, for example, 0.2 mm. These linear elements 101a through 101d, 102a through 102d, and 103a through 103d are arranged in square shapes as shown in FIG. 1(a).

Linear linking elements 104a through 104d are electrical conductors with element length L2 of approximately ⅖ wavelength (3.3 mm), and an element width of, for example, 0.2 mm. Linear linking element 104a is connected between linear element 101a and linear element 102b, linear linking element 104b is connected between linear element 101b and linear element 103a, linear linking element 104c is connected between linear element 101c and linear element 102d, and linear linking element 104d is connected between linear element 101d and linear element 103c.

Linear detour elements 105a and 105b are folded-back electrical conductors with a full length of approximately ⅖ wavelength (3.3 mm), element length L3 of approximately ⅕ wavelength (1.7 mm), and an element width of, for example, 0.2 mm. Linear detour element 105a is connected between linear element 102a and linear element 102c, and linear detour element 105b is connected between linear element 103b and linear element 103d.

Feed point 106a is provided between linear elements 101a and 101b, and feed point 106b is provided between linear elements 101c and 101d. Linear elements 102a and 102b, linear elements 102c and 102d, linear elements 103a and 103b, and linear elements 103c and 103d, are connected.

Linear antenna elements in which rhombic antenna sections are connected in an array configuration are configured with linear elements 101a through 101d, 102a through 102d, and 103a through 103d, linear linking elements 104a and 104b, linear detour elements 105a and 105b, and feed points 106a and 106b, configured as described above.

Rectangles in general including the above square shapes are applicable to the above described rhombic antenna sections. For example, quadrilaterals, squares, parallelograms, and trapezoids—as well as curved and round shapes—are applicable. Hereinafter, when “rhombic antenna section” is referred to, it is used as a generic term for antenna sections shaped as quadrilaterals, squares, parallelograms, or trapezoids, as well as curved or round shapes for convenience of explanation.

When linear antenna elements are excited from feed point 106a, feed point 106b is shorted, and linear elements 101c and 101d operate so as to be connected. Conversely, when linear antenna elements are excited from feed point 106b, feed point 106a is shorted, and linear elements 101a and 101b operate so as to be connected. By switching feed points in this way and exciting linear antenna elements, it is possible to switch the main beam in two directions with one linear antenna element.

FIG. 1(b) is an arrow view showing the configuration of an antenna apparatus according to Embodiment 1 of the present invention, viewed from the +X side of FIG. 1(a). In this figure, dielectric substrate 107 has thickness t of approximately 0.05 wavelength (0.4 mm), and is arranged on the −Z side parallel to the surface (XY plane) on which the linear antenna elements are arranged. Plate reflector 108 is a conductive plate arranged at a position where distance h is approximately 0.6 wavelength (5 mm) on the −Z side from the surface (XY plane) on which the linear antenna elements are arranged.

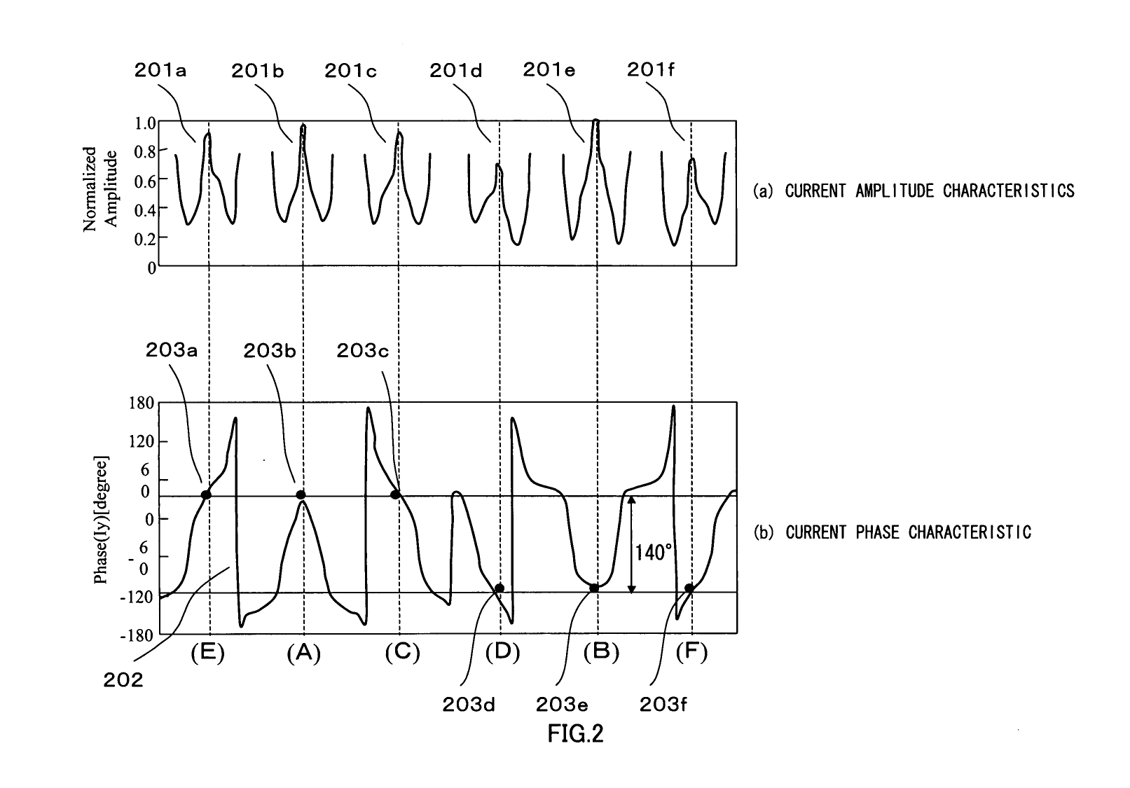

The operation of the above described antenna apparatus will now be explained using FIG. 2. FIG. 2 is a drawing showing current distribution on the linear antenna elements when feed point 106a is excited and feed point 106b is shorted, FIG. 2(a) shows current amplitude characteristics, and FIG. 2(b) shows current phase characteristics. Symbols (A) through (F) shown on the horizontal axis in FIG. 2 correspond to the positions indicated by symbols (A) through (F) in FIG. 1.

In FIG. 2(a), current amplitude characteristic 201a indicates the current amplitude on linear elements 103a and 103b, and it can be confirmed that the current amplitude is at its peak value at point (E). Similarly, characteristic 201b indicates the current amplitude on linear elements 101a and 101b, characteristic 201c indicates the current amplitude on linear elements 102a and 102b, characteristic 201d indicates the current amplitude on linear elements 102c and 102d, characteristic 201e indicates the current amplitude on linear elements 101c and 101d, and characteristic 201f indicates the current amplitude on linear elements 103c and 103d, and it can be confirmed that the current amplitudes are at their peak values at point (A), point (C), point (D), point (B) and point (F), respectively.

In FIG. 2(b), current phase characteristic 202 indicates the current phase of the Y direction component. Here, phases 203a, 203b, 203c, 203d, 203e and 203f are the current phases at point (E), point (A), point (C), point (D), point (B) and point (F), respectively.

From FIG. 2(b), it can be confirmed that the peak points on linear elements arranged on the −X side in FIG. 1—that is, phases 203a, 203b and 203c at point (A), point (C) and point (E)—approximately coincide, and the peak points on linear elements arranged on the +X side—that is, phases 203d, 203e and 203f at point (B), point (D) and point (F)—approximately coincide. At this time, it can be confirmed that a phase difference of approximately 140 degrees occurs between phases 203a, 203b and 203c, and phases 203d, 203e and 203f. Consequently, when the antenna apparatus according to Embodiment 1 of the present invention is excited from feed point 106a, a beam tilted toward the +X side is obtained, and the antenna apparatus operates as a beam tilt antenna. Conversely, when the antenna apparatus is excited from feed point 106b, a beam tilted toward the −X side is obtained.

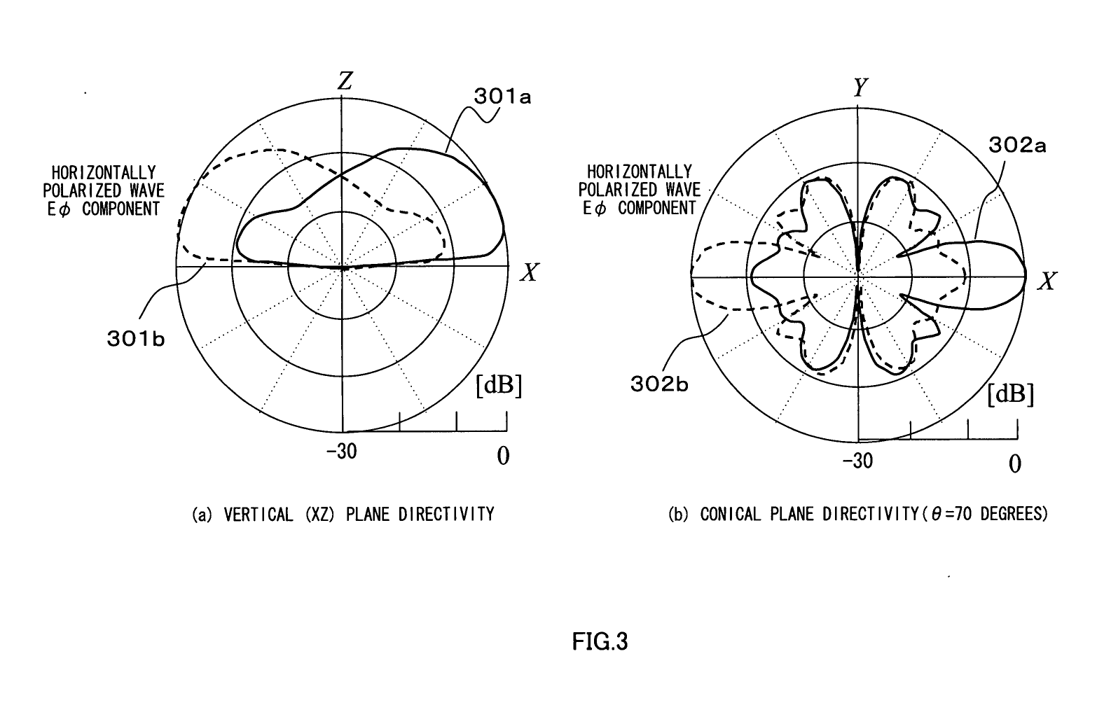

FIG. 3 is a drawing showing the directivity of an antenna apparatus according to Embodiment 1 of the present invention. FIG. 3(a) shows the directivity of the vertical (XZ) plane, and FIG. 3(b) shows the conical plane directivity with elevation angle θ of 70 degrees.

In FIG. 3(a), directivity 301a indicated by a solid line shows the directivity of a horizontally polarized wave (Eφ) component when linear antenna elements are excited from feed point 106a and feed point 106b is shorted, and it can be confirmed that a main beam tilted in a direction in which elevation angle θ is 70 degrees is obtained. Directivity 301b indicated by a dotted line shows the directivity of a horizontally polarized wave (Eφ) component when linear antenna elements are excited from feed point 106b and feed point 106a is shorted, and it can be confirmed that a main beam tilted in a direction in which elevation angle θ is 70 degrees is obtained.

In FIG. 3(b), directivity 302a indicated by a solid line shows the directivity of a horizontally polarized wave (Eφ) component when linear antenna elements are excited from feed point 106a and feed point 106b is shorted, as in the case of directivity 301a in FIG. 3(a), and it can be confirmed that the main beam is directed toward the +X direction. Directivity 302b indicated by a dotted line shows the directivity of a horizontally polarized wave (Eφ) component when linear antenna elements are excited from feed point 106b and feed point 106a is shorted, as in the case of directivity 301b in FIG. 3(a), and it can be confirmed that the main beam is directed toward the −X direction. At this time, for both directivity 302a and directivity 302b, the main beam directional gain is 14 dBi, the conical plane half-power beam width is 20 degrees, and the F/B ratio (ratio of main beam to back lobe) is 11 dB.

Here, since Non-Patent Document 1 discloses that the directional gain of a detour element loaded loop antenna is 10.5 dB and its conical plane half-power beam width is approximately 60 degrees, it can be seen that higher gain and narrower directivity can be achieved by connecting rhombic antenna sections in an array configuration like the antenna apparatus shown in Embodiment 1.

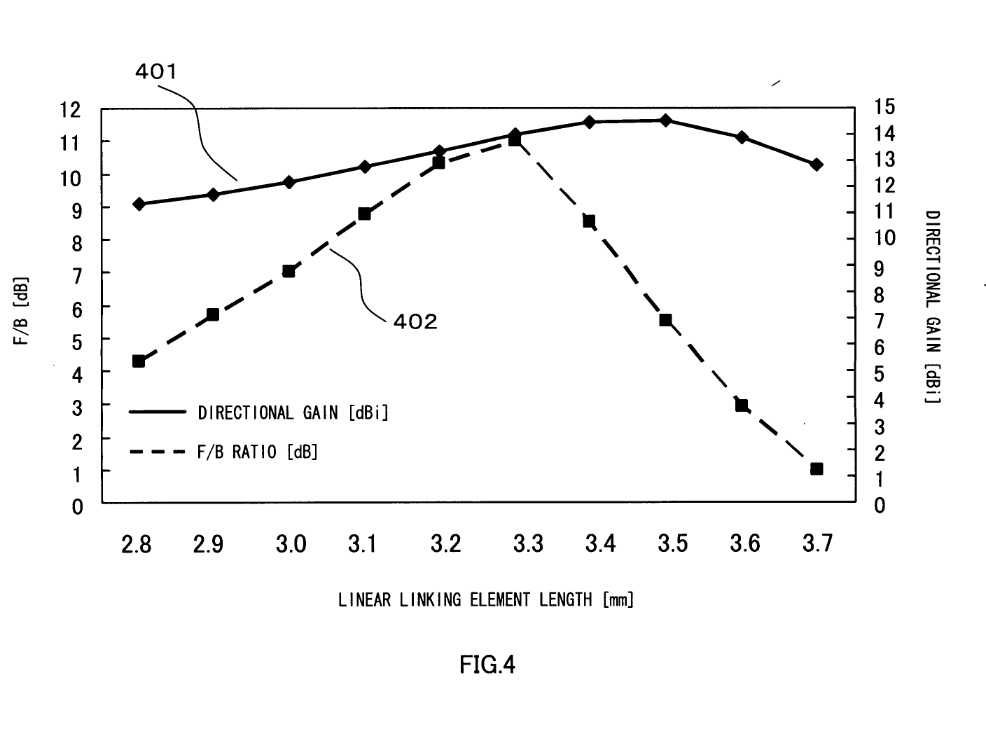

FIG. 4 is a drawing showing the relationship between directional gain and the F/B ratio when the length of linear linking elements 104a through 104d is varied between 2.8 mm and 3.7 mm. From this figure, it can be confirmed that the variation width of directional gain 401 is small, while the variation width of F/B ratio 402 is large. It can thus be confirmed that the length of linear linking elements 104a through 104d at which directional gain 401 reaches 12.5 dBi or above and F/B ratio 402 reaches 8 dB or above is between 3.1 mm (approximately 0.36 wavelength) and 3.4 mm (approximately 0.40 wavelength.)

Thus, according to this embodiment, by connecting rhombic antenna sections in an array configuration and arranging a plate reflector at a predetermined distance from the linear antenna elements, it is possible to achieve higher gain and narrower directivity with a small, planar configuration suitable for an antenna for road-to-vehicle communication or vehicle-to-vehicle communication. Also, by switching between two feed points, it is possible to switch the main beam in two directions, thereby improving transmission quality by switching the beam in accordance with the vehicle driving condition. Furthermore, since operation is possible by feeding one linear antenna element point, compared to a complex array configuration using distribution feeding, it is possible to achieve high space-efficiency of the antenna apparatus and reduce feed loss.

In this embodiment, a case has been described in which detour elements of a 3-element detour element loaded loop antenna are connected, but any number of elements may be used within the scope of the above described operating principles.

Also, in this embodiment, a case has been described in which rhombic antenna elements are connected, but a similar effect can also be obtained with circular antenna elements.

### Embodiment 2

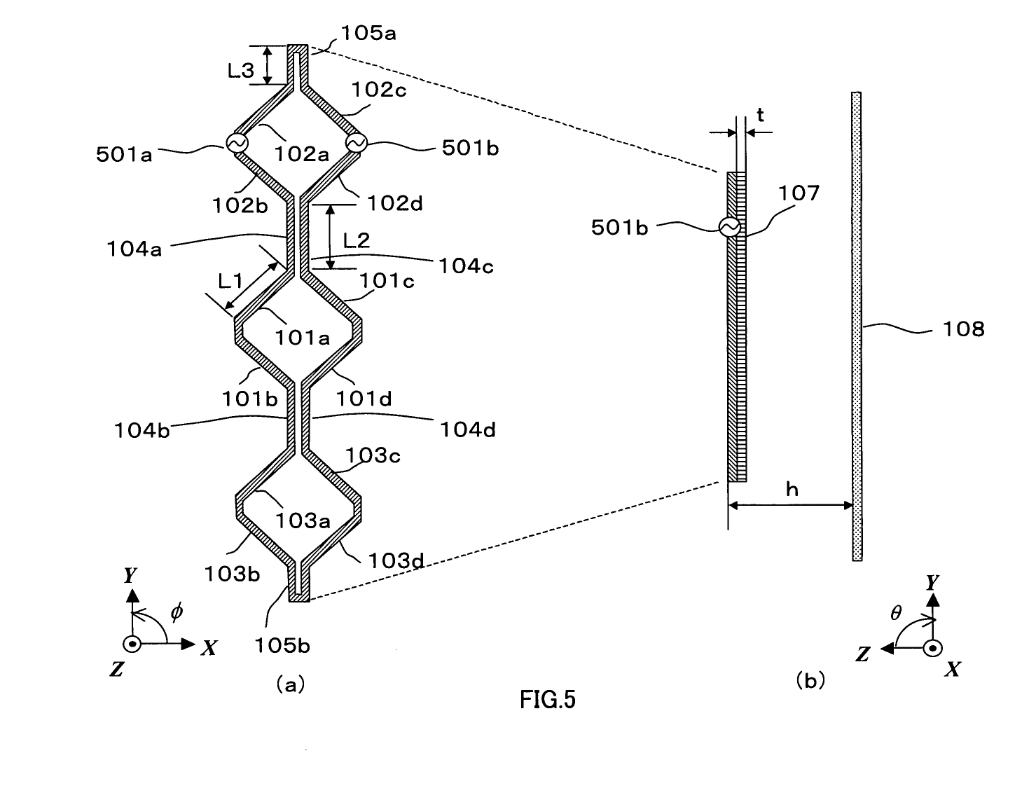

FIG. 5 is a drawing showing the configuration of an antenna apparatus according to Embodiment 2 of the present invention. FIG. 5(a) is a planar view showing the configuration of the antenna apparatus, and FIG. 5(b) is an arrow view showing the configuration of the antenna apparatus viewed from the +X side of FIG. 5(a). In these figures, parts common to FIG. 1 are assigned the same reference numerals as in FIG. 1 without further explanations. Below, a case will be described in which an antenna is created on a dielectric substrate of, for example, ∈r=2.26, assuming that its operating frequency is 25 GHz and one wavelength (one effective wavelength) is 8.6 mm. The coordinate axes shown in the figures are defined for convenience of explanation.

Feed point 501a is provided between linear elements 102a and 102b, and feed point 501b is provided between linear elements 102c and 102d. Linear elements 101a and 101b, linear elements 101c and 101d, linear elements 103a and 103b, and linear elements 103c and 103d, are connected.

When linear antenna elements are excited from feed point 501a, feed point 501b is shorted, and linear elements 102c and 102d operate so as to be connected. Conversely, when linear antenna elements are excited from feed point 501b, feed point 501a is shorted, and linear elements 102a and 102b operate so as to be connected. In this way, by switching feed points and exciting linear antenna elements, it is possible to switch the main beam in two directions with one linear antenna element.

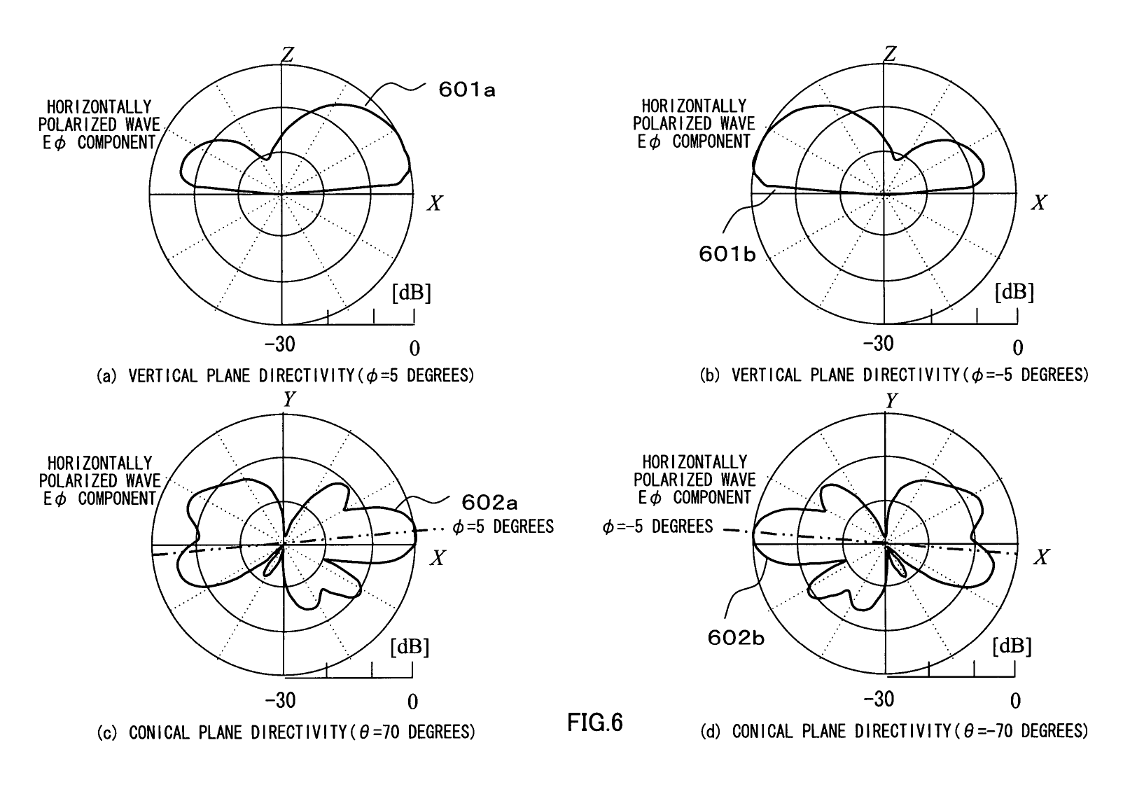

FIG. 6(a) shows the vertical plane directivity when linear antenna elements are excited from feed point 501a and feed point 501b is shorted (φ=5 degrees). FIG. 6(b) shows the vertical plane directivity when linear antenna elements are excited from feed point 501b and feed point 501a is shorted (φ=−5 degrees). FIG. 6(c) shows the conical plane directivity with elevation angle θ of 70 degrees when linear antenna elements are excited from feed point 501a and feed point 501b is shorted. FIG. 6(d) shows the conical plane directivity with elevation angle θ of 70 degrees when linear antenna elements are excited from feed point 501b and feed point 501a is shorted.

In FIG. 6(a), directivity 601a shows the directivity of a horizontally polarized wave (Eφ) component, and it can be confirmed that a main beam tilted in a direction in which elevation angle θ is 70 degrees is obtained when φ is 5 degrees. In FIG. 6(b), directivity 601b shows the directivity of a horizontally polarized wave (Eφ) component, and it can be confirmed that a main beam tilted in a direction in which elevation angle θ is 70 degrees is obtained when φ is −5 degrees.

In FIG. 6(c), directivity 602a shows the directivity of a horizontally polarized wave (Eφ) component, as in the case of directivity 601a in FIG. 6(a), and it can be confirmed that the main beam is directed toward the direction in which φ is 5 degrees. Directivity 602b shown in FIG. 6(d) shows the directivity of a horizontally polarized wave (Eφ) component, as in the case of directivity 601b in FIG. 6(b), and it can be confirmed that the main beam is directed toward the direction in which φ is −5 degrees. At this time, for both directivity 602a and directivity 602b, the main beam directional gain is 13.2 dBi, the conical plane half-power beam width is 21 degrees, and the F/B ratio is 7 dB.

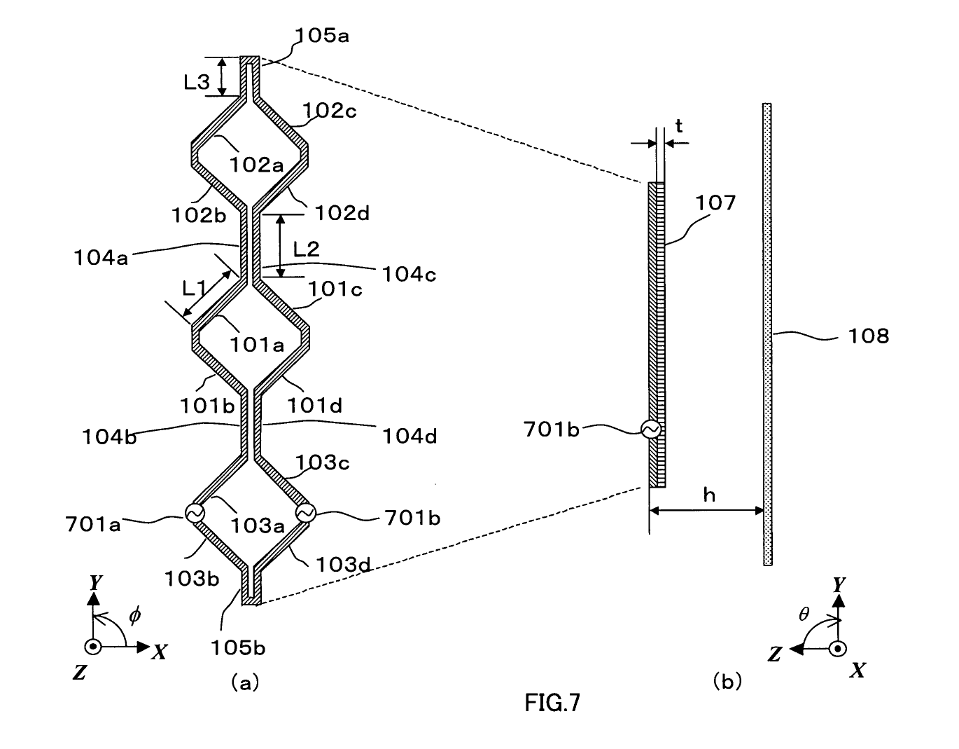

FIG. 7 is a drawing showing another configuration of an antenna apparatus according to Embodiment 2 of the present invention. FIG. 7(a) is a planar view showing the configuration of the antenna apparatus, and FIG. 7(b) is an arrow view showing the configuration of the antenna apparatus viewed from the +X side of FIG. 7(a). In these figures, parts common to FIG. 1 are assigned the same reference numerals as in FIG. 1 without further explanations. Below, a case will be described in which an antenna is created on a dielectric substrate of ∈r=2.26, assuming that its operating frequency is 25 GHz and one wavelength (one effective wavelength) is 8.6 mm. The coordinate axes shown in the figures are defined for convenience of explanation.

When linear antenna elements are excited from feed point 701a, feed point 701b is shorted, and linear elements 103c and 103d operate so as to be connected. Conversely, when linear antenna elements are excited from feed point 701b, feed point 701a is shorted, and linear elements 103a and 103b operate so as to be connected. In this way, by switching feed points and exciting linear antenna elements, it is possible to switch the main beam in two directions with one linear antenna element.

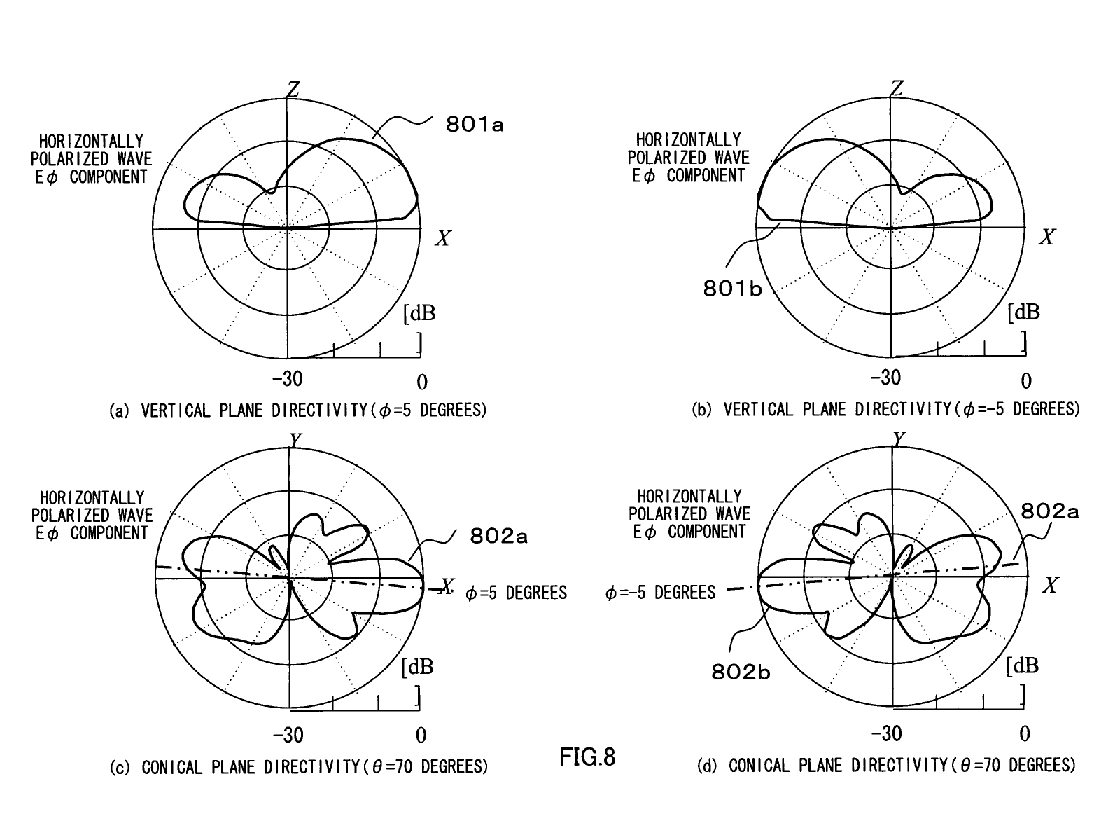

FIG. 8 is a drawing showing the directivity of the antenna apparatus according to Embodiment 2 of the present invention shown in FIG. 7. FIG. 8(a) shows the vertical plane directivity when linear antenna elements are excited from feed point 701a and feed point 701b is shorted (φ=−5 degrees). FIG. 8(b) shows the vertical plane directivity when linear antenna elements are excited from feed point 701b and feed point 701a is shorted (φ=5 degrees). FIG. 8(c) shows the directivity of a conical plane with elevation angle θ of 70 degrees when linear antenna elements are excited from feed point 701a and feed point 701b is shorted. FIG. 8(d) shows the directivity of a conical plane with elevation angle θ of 70 degrees when linear antenna elements are excited from feed point 701b and feed point 701a is shorted.

In FIG. 8(a), directivity 801a shows the directivity of a horizontally polarized wave (Eφ) component, and it can be confirmed that a main beam tilted in a direction in which elevation angle θ is 70 degrees is obtained when φ is −5 degrees. In FIG. 8(b), directivity 801b shows the directivity of a horizontally polarized wave (Eφ) component, and it can be confirmed that a main beam tilted in a direction in which elevation angle θ is 70 degrees is obtained when φ is 5 degrees.

In FIG. 8(c), directivity 802a shows the directivity of a horizontally polarized wave (Eφ) component, as in the case of directivity 801a in FIG. 8(a), and it can be confirmed that the main beam is directed toward the direction in which φ is −5 degrees. Directivity 802b shown in FIG. 8(d) shows the directivity of a horizontally polarized wave (Eφ) component, as in the case of directivity 801b in FIG. 8(b), and it can be confirmed that the main beam is directed toward the direction in which φ is 5 degrees. At this time, for both directivity 802a and directivity 802b, the main beam directional gain is 13.2 dBi, the conical plane half-power beam width is 21 degrees, and the F/B ratio is 7 dB.

Thus, according to this embodiment, by employing a configuration in which feed points are arranged asymmetrically with respect to the linear antenna elements and two feed points are switched, it is possible not only to switch the main beam direction but also to tilt the beam in the conical plane.

### Embodiment 3

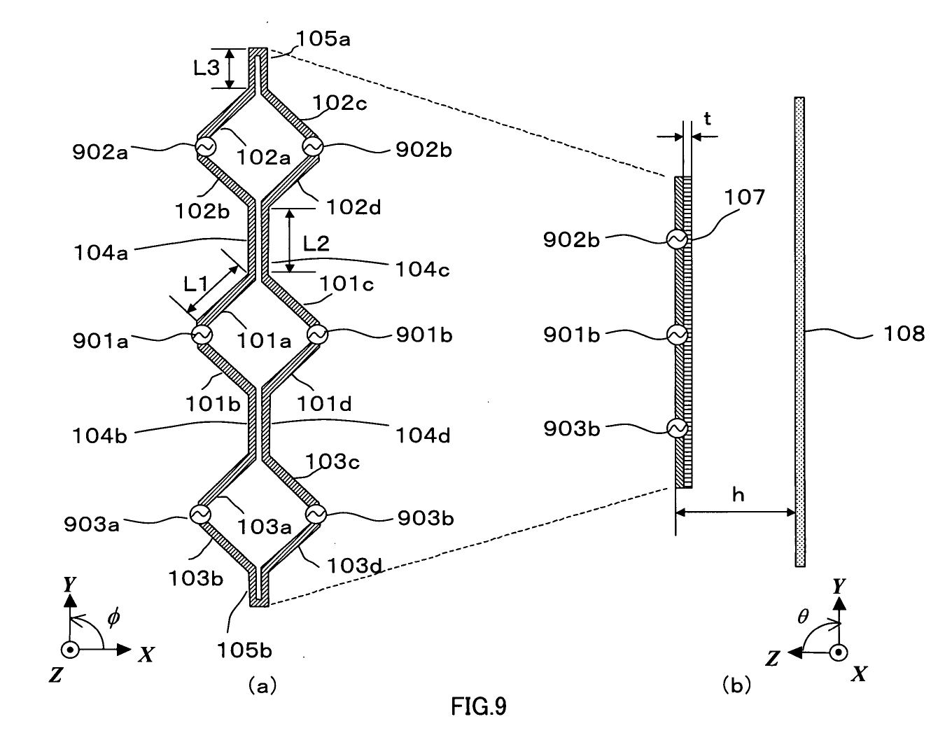

FIG. 9 is a drawing showing the configuration of an antenna apparatus according to Embodiment 3 of the present invention. FIG. 9(a) is a planar view showing the configuration of the antenna apparatus, in which feed points 901a, 901b, 902a, 902b, 903a and 903b are provided at the peaks opposite to the respective rhombic antenna sections, and the feed points are switched. FIG. 9(b) is an arrow view showing the configuration of the antenna apparatus viewed from the +X side of FIG. 9(a). In these figures, parts common to FIG. 1 are assigned the same reference numerals as in FIG. 1 without further explanations. Below, a case will be described in which an antenna is created on a dielectric substrate of, for example, ∈r=2.26, assuming that its operating frequency is 25 GHz and one wavelength (one effective wavelength) is 8.6 mm. The coordinate axes shown in the figures are defined for convenience of explanation.

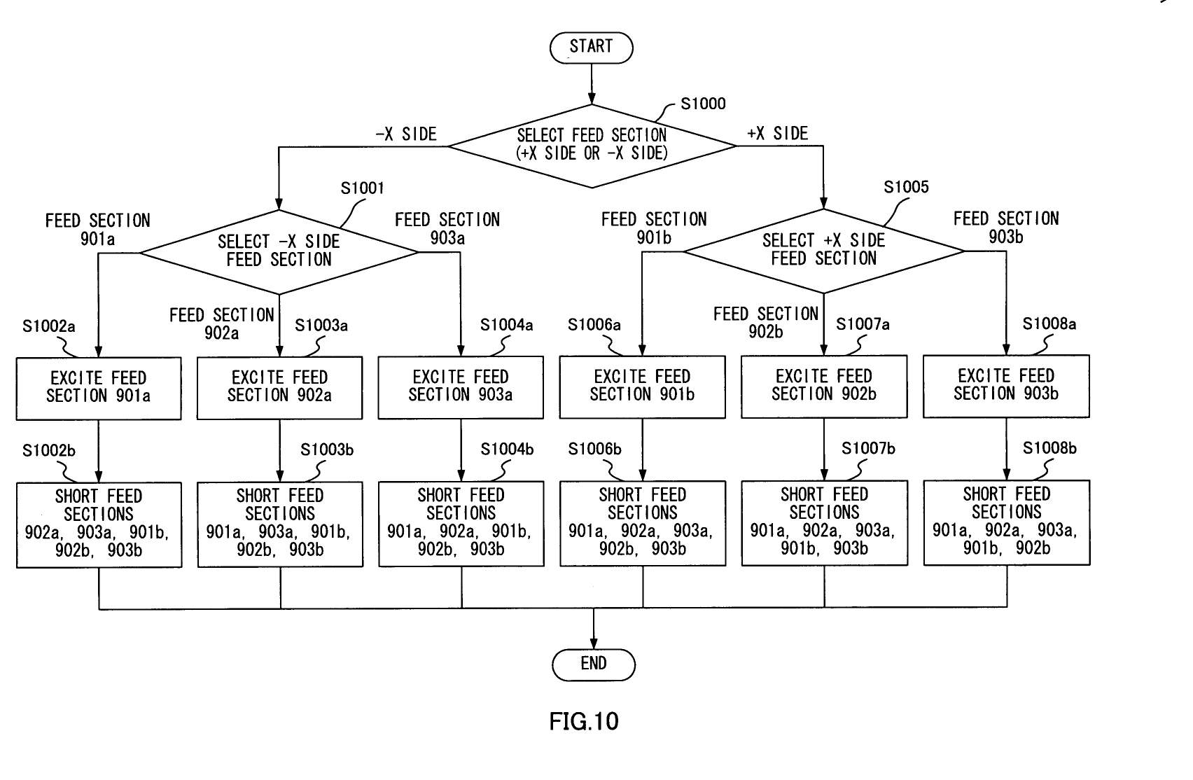

An example of feed point switching according to an antenna apparatus of this embodiment will be described here using a flowchart shown in FIG. 10.

First, feeding power to either the −X side or the +X side of the antenna apparatus is selected (S1000). When the −X side is fed, the processing flow proceeds to S1001. In S1001, one of the −X side feed points is selected. If feed point 901a is selected here, feed point 901a is excited (S1002a). At this time, simultaneously, feed points 902a, 903a, 901b, 902b and 903b are shorted (S1002b). In this way, linear antenna elements are excited from feed point 901a, and the same effect is obtained as when feed point 106a is excited in Embodiment 1.

If, feed point 902a is selected, feed point 902a is excited (S1003a). At this time, feed points 901a, 903a, 901b, 902b and 903b are simultaneously shorted (S1003b). In this way, linear antenna elements are excited from feed point 902a, and the same effect is obtained as when feed point 501a is excited in Embodiment 2.

If feed point 903a is selected, feed point 903a is excited (S1004a). At this time, simultaneously, feed points 901a, 902a, 901b, 902b and 903b are shorted (S1004b) In this way, linear antenna elements are excited from feed point 903a, and the same effect is obtained as when feed point 701a is excited in Embodiment 2.

Next, the case where the +X side is fed will be considered. In S1005, one of the +X side feed points is selected. If feed point 901b is selected here, feed point 901b is excited (S1006a). At this time, feed points 901a, 902a, 903a, 902b and 903b are simultaneously shorted (S1006b). In this way, linear antenna elements are excited from feed point 901b, and the same effect is obtained as when feed point 106b is excited in Embodiment 1.

If feed point 902b is selected, feed point 902b is excited (S1007a). At this time, feed points 901a, 902a, 903a, 901b and 903b are simultaneously shorted (S1007b). In this way, linear antenna elements are excited from feed point 902b, and the same effect is obtained as when feed point 501b is excited in Embodiment 2.

If feed point 903b is selected, feed point 903b is excited (S1008a). At this time, feed points 901a, 902a, 903a, 901b and 902b are simultaneously shorted (S1008b). In this way, linear antenna elements are excited from feed point 903b, and the same effect is obtained as when feed point 701b is excited in Embodiment 2.

Thus, according to this embodiment, by providing a plurality of feed points and switching these, it is possible to switch the main beam direction in the vertical plane and conical plane.

### Embodiment 4

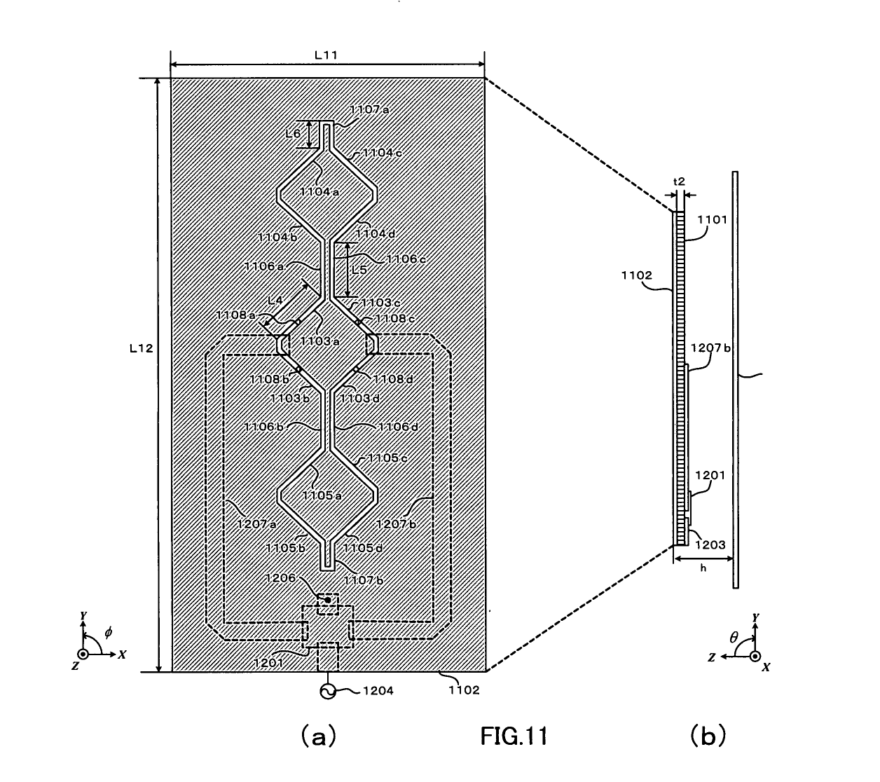

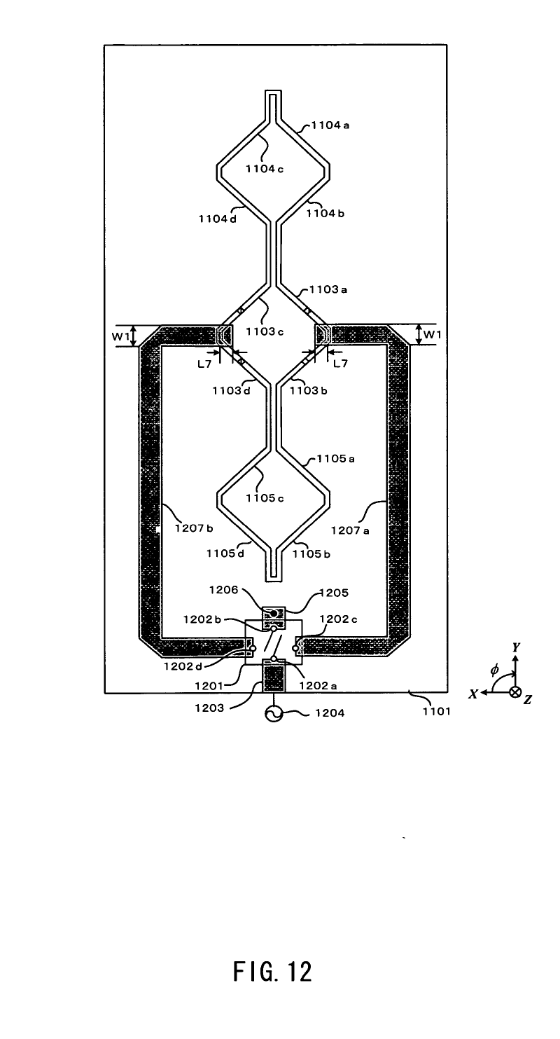

FIG. 11 and FIG. 12 are drawings showing the configuration of an antenna apparatus according to Embodiment 4 of the present invention. FIG. 11(a) is a planar view showing the antenna apparatus viewed from the +Z side, and FIG. 11(b) is an arrow view showing the antenna apparatus viewed from the +X side. FIG. 12 is a planar view of the antenna apparatus viewed from the −Z side, excluding plate reflector 108. In FIG. 11 and FIG. 12, parts common to FIG. 1 are assigned the same reference numerals as in FIG. 1 without further explanations. In the following description, the operating frequency is assumed to be 25 GHz. The coordinate axes shown in FIG. 11 and FIG. 12 are defined for convenience of explanation.

In FIG. 11, dielectric substrate 1101 has relative permittivity ∈r of, for example, 3.45, and thickness t of approximately 0.04 wavelength (0.3 mm), and dimensions L11×L12 are 2 wavelengths×4.3 wavelengths (14.5 mm×31 mm.) At this time, one wavelength (one effective wavelength) is assumed to be 7.2 mm.

Copper foil layer 1102 is copper foil bonded to the +Z side of dielectric substrate 1101. Slot elements 1103a through 1103d, 1104a through 1104d, and 1105a through 1105d, are voids (copper foil patterns) formed by removing copper foil layer 1102, with element length L4 of approximately ⅓ wavelength (2.4 mm), and an element width of, for example, 0.2 mm. These slot elements 1103a through 1103d, 1104a through 1104d, and 1105a through 1105d are arranged in square shapes as shown in FIG. 11(a).

Slot linking elements 1106a through 1106d, and slot detour elements 1107a and 1107b, are also voids (copper foil patterns) formed by removing copper foil layer 1102, with element length L5 of approximately 0.43 wavelength (3.1 mm) and element length L6 of approximately 0.14 wavelength (1 mm) respectively, and an element width of, for example, 0.2 mm. Slot linking element 1106a connects slot elements 1103a and 1104b, slot linking element 1106b connects slot elements 1103b and 1105a, slot linking element 1106c connects slot elements 1103c and 1104d, and slot linking element 1106d connects slot elements 1103d and 1105c. Furthermore, slot detour element 1107a connects slot elements 1104a and 1104c, and slot detour element 1107b connects slot elements 1105b and 1105d. In addition, slot elements 1103a and 1103b, slot elements 1103c and 1103d, slot elements 1104a and 1104b, slot elements 1104c and 1104d, slot elements 1105a and 1105b, and slot elements 1105c and 1105d, are connected.

Connecting conductors 1108a through 1108d are formed in a square shape as a copper foil pattern, for example, in slot elements 1103a through 1103d, and the inner and outer copper foil layers of the slot elements are connected so that slot elements 1103a through 1103d are respectively divided approximately at their center. By dividing slot elements 1103a through 1103d by means of connecting conductors 1108a through 1108d in this way, it is possible to implement an antenna apparatus in which impedance matching is easily achieved and that has a good F/B ratio.

Slot antenna elements with rhombic slot antenna sections connected in an array configuration are configured with slot elements 1103a through 1103d, 1104a through 1104d, and 1105a through 1105d, slot linking elements 1106a through 1106d, slot detour elements 1107a and 1107b, and connecting conductors 1108a through 1108d, configured as described above.

Switch 1201 is a DPDT (Double Pole Double Throw) switch having two input terminals 1202a and 1202b and two output terminals 1202c and 1202d. This switch 1201 operates so that, when input terminal 1202a is connected to output terminal 1202c, input terminal 1202b and output terminal 1202d are connected, and when input terminal 1202a is connected to output terminal 1202d, input terminal 1202b and output terminal 1202c are connected.

Feed point 1204 is connected to input terminal 1202a via microstrip line 1203, and input terminal 1202b is connected to copper foil pattern 1205 and is grounded to copper foil layer 1102 which is a grounding conductor via through-hole 1206. Also, microstrip line 1207a is connected to output terminal 1202c, and microstrip line 1207b is connected to output terminal 1202d. Above described microstrip line 1203 and copper foil pattern 1205 are copper foil patterns formed on the −Z side of dielectric substrate 1101.

Microstrip line 1207a is formed by means of a copper foil pattern on the −Z side of dielectric substrate 1101, with one end arranged so as to pass through the junction of slot element 1103a and slot element 1103b, and the other end connected to output terminal 1202c of switch 1201. Similarly, microstrip line 1207b is formed by means of a copper foil pattern on the −Z side of dielectric substrate 1101, with one end arranged so as to pass through the junction of slot element 1103c and slot element 1103d, and the other end connected to output terminal 1202d of switch 1201.

Width W1 of microstrip lines 1207a and 1207b is set to 0.6 mm so that the characteristic impedance is 50Ω. Distance L7 from the end of microstrip line 1207a to the junction of slot element 1103a and slot element 1103b, and distance L7 from the end of microstrip line 1207b to the junction of slot element 1103c and slot element 1103d, are set to 0.45 mm.

As the antenna apparatus of this embodiment shown in FIG. 11 and FIG. 12 can be considered to be substantially equivalent to the antenna apparatus shown in FIG. 1 with the linear elements replaced by slot elements, its operation can be explained by substituting magnetic fields for electrical fields. Therefore, whereas the main polarized wave component of the antenna apparatus shown in FIG. 1 is a horizontal (Eφ) component, the main polarized wave component of the antenna apparatus shown in FIG. 11 and FIG. 12 is a vertical (Eθ) component.

The operation in an antenna apparatus with the above described configuration when the antenna apparatus is excited from microstrip line 1207a will now be explained. A signal excited from feed point 1204 is inputted to input terminal 1202a of switch 1201. At this time, switch 1201 operates so that input terminal 1202a and output terminal 1202c, and input terminal 1202b and output terminal 1202d, are connected respectively. Thus, the signal inputted to input terminal 1202a is inputted to microstrip line 1207a via output terminal 1202c.

On the other hand, microstrip line 1207b is grounded via input terminal 1202b and output terminal 1202d. Since the antenna elements are configured with slot elements, if magnetic fields are considered to be substituted for the electrical fields in the case of linear elements, it is necessary to create an open state at the junction of microstrip line 1207b and a slot element, that is, to ground the other end of microstrip line 1207b. Therefore, the length from the junction of microstrip line 1207b and a slot element to the grounding point—that is, the overall electrical length of microstrip line 1207b, copper foil pattern 1205, through-hole 1206, and switch 1201—must be set to an odd multiple of ¼ wavelength. By this means, it is possible to achieve high directional gain and a good F/B ratio.

Similarly, when the antenna apparatus is excited from microstrip line 1207b, switch 1201 operates so that input terminal 1202a and output terminal 1202d, and input terminal 1202b and output terminal 1202c, are connected respectively. At this time, it is necessary to create an open state at the junction of microstrip line 1207a and a slot element, and therefore the length from the junction of microstrip line 1207a and a slot element to the grounding point must be set to an odd multiple of ¼ wavelength.

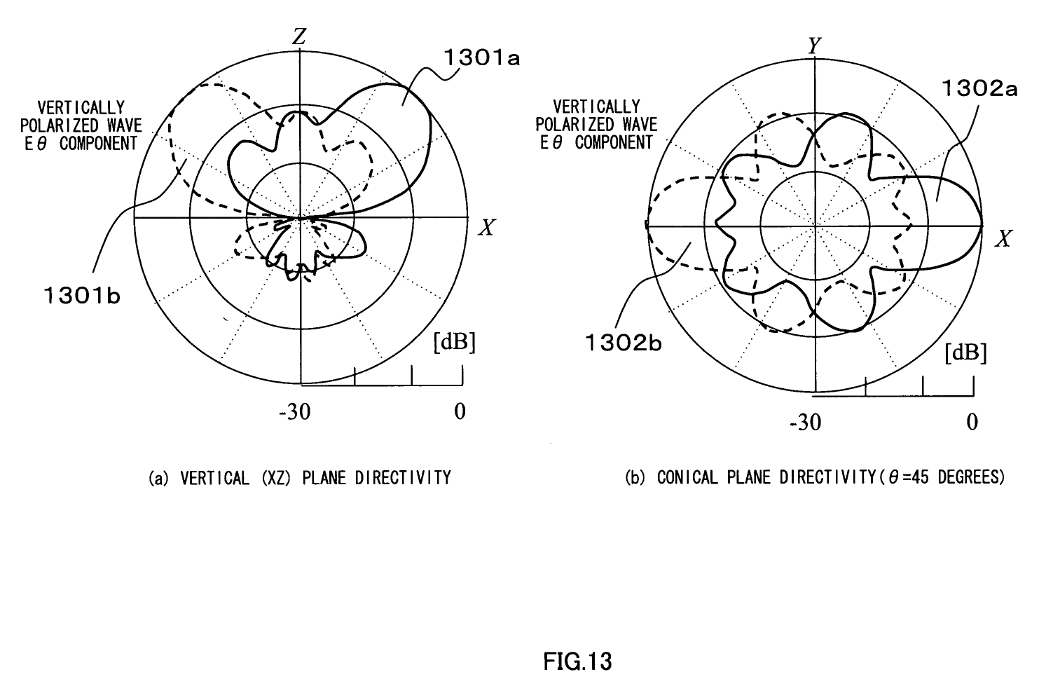

FIG. 13 is a drawing showing the directivity of an antenna apparatus according to Embodiment 4 of the present invention. FIG. 13(a) shows the directivity of the vertical (XZ) plane, and FIG. 13(b) shows the conical plane directivity with elevation angle θ of 45 degrees.

In FIG. 13(a), directivity 1301a indicated by a solid line shows the directivity of a vertically polarized wave (Eθ) component when the antenna apparatus is excited from microstrip line 1207a, and it can be confirmed that a main beam tilted in a direction in which elevation angle θ is 45 degrees is obtained. Directivity 1301b indicated by a dotted line shows the directivity of a vertically polarized wave (Eθ) component when the antenna apparatus is excited from microstrip line 1207b, and it can be confirmed that a main beam tilted in a direction in which elevation angle θ is 45 degrees is obtained.

In FIG. 13(b), directivity 1302a indicated by a solid line shows the directivity of a vertically polarized wave (Eθ) component when the antenna apparatus is excited from microstrip line 1207a, as in the case of directivity 1301a in FIG. 13(a), and it can be confirmed that the main beam is directed toward the +X direction. Directivity 1302b indicated by a dotted line shows the directivity of a vertically polarized wave (Eθ) component when the antenna apparatus is excited from microstrip line 1207b, as in the case of directivity 1301b in FIG. 13(a), and it can be confirmed that the main beam is directed toward the −X direction. At this time, for both directivity 1302a and directivity 1302b, the main beam directional gain is 13.54 dBi, the conical plane half-power beam width is 27 degrees, and the F/B ratio is 11.2 dB.

Thus, according to this embodiment, it is possible to implement an antenna apparatus in which impedance matching and power feeding are simplified using microstrip lines. Furthermore, it is possible to switch the main beam in two directions by switching the power feeding to the microstrip lines using a switching circuit.

In this embodiment, slot elements are formed by means of copper foil patterns on a dielectric substrate, but a similar effect can also be obtained, for example, if slot elements are formed by providing voids in a conductive plate.

In this embodiment, connecting conductors have been described as being formed as copper foil patterns within slot elements, and connecting the inner copper foil layer and outer copper foil layer within slot elements so that the slot elements are divided approximately at their center, but a similar effect can also be obtained if connecting conductors are formed in the same plane as the microstrip lines, and connect the inner copper foil layer and outer copper foil layer via a through-hole.

In this embodiment, a configuration has been described in which connecting conductors are provided only in the center rhombic slot antenna section, but connecting conductors may also be provided in the rhombic slot antenna sections at both ends.

In this embodiment, a configuration has been described in which connecting conductors are provided only in the center rhombic slot antenna section, but connecting conductors may also be provided in a plurality of rhombic slot antenna sections.

In this embodiment, a case has been described in which a single DPDT switch is used as a switch, but a plurality of switches may also be used, as in a configuration, for example, using three SPDT (Single Pole Double Throw) switches, for example.

In this embodiment, a case has been described in which one terminal of a switch is grounded, and the length from the junction of a microstrip line and slot element to the grounding point is made an odd multiple of ¼ wavelength, but high directional gain and a good F/B ratio can also be achieved with a configuration in which, for example, one terminal of the switch is left open, and the length from the junction of a microstrip line and slot element to the grounding point is made an integral multiple of ½ wavelength.

### Embodiment 5

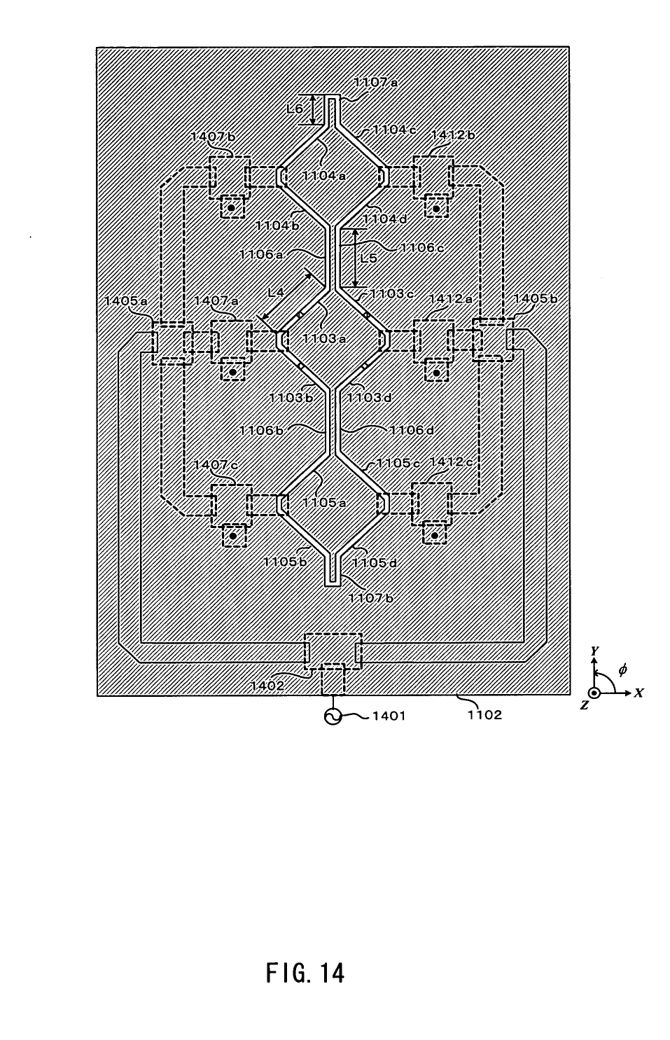

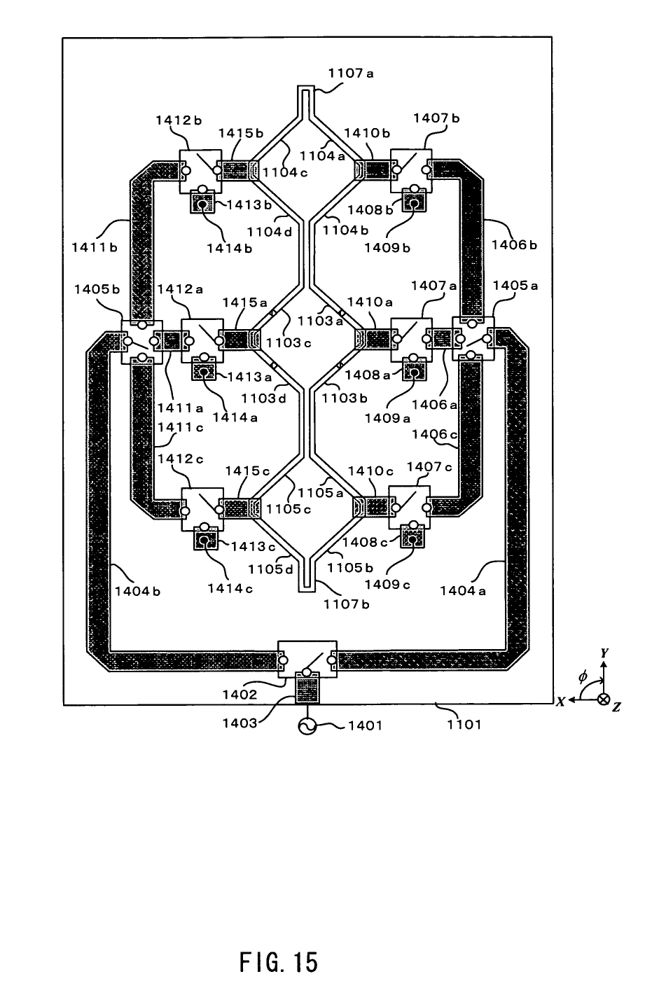

FIG. 14 and FIG. 15 are drawings showing the configuration of an antenna apparatus according to Embodiment 5 of the present invention. FIG. 14 is a planar view showing the antenna apparatus viewed from the +Z side, and FIG. 15 is a planar view from the −Z side, excluding the plate reflector. In FIG. 14 and FIG. 15, parts common to FIG. 11 are assigned the same reference numerals as in FIG. 11 without further explanations. Although not shown in these figures, plate reflector 108 is arranged approximately parallel to, and at a predetermined distance from, the dielectric substrate. In the following description, the operating frequency is assumed to be 25 GHz. The coordinate axes shown in FIG. 14 and FIG. 15 are defined for convenience of explanation.

Switch 1402 is an SPDT (Single Pole Double Throw) switch having one input terminal and two output terminals. The input terminal is connected to feed point 1401 via microstrip line 1403, and the two output terminals are connected to microstrip lines 1404a and 1404b. Microstrip line 1403 and microstrip lines 1404a and 1404b are copper foil patterns formed on the −Z side of dielectric substrate 1101.

Switches 1405a and 1405b are SP3T (Single Pole 3 Throw) switches having one input terminal and three output terminals. In switch 1405a, the input terminal is connected to microstrip line 1404a, and the three output terminals are connected to microstrip lines 1406a through 1406c respectively. Microstrip lines 1406a through 1406c are copper foil patterns formed on the −Z side of dielectric substrate 1101. In switch 1405b, the input terminal is connected to microstrip line 1404b, and the three output terminals are connected to microstrip lines 1411a through 1411c respectively. Microstrip lines 1411a through 1411c are also copper foil patterns formed on the −Z side of dielectric substrate 1101.

Switches 1407a through 1407c are SPDT (Single Pole Double Throw) switches having one input terminal and two output terminals. In switch 1407a, the input terminal is connected to microstrip line 1406a, and the two output terminals are connected to copper foil pattern 1408a and microstrip line 1410a. Copper foil pattern 1408a is grounded to grounding conductor 1102 via through-hole 1409a. In switch 1407b, the input terminal is connected to microstrip line 1406b, and the two output terminals are connected to copper foil pattern 1408b and microstrip line 1410b. Copper foil pattern 1408b is grounded to grounding conductor 1102 via through-hole 1409b. In switch 1407c, the input terminal is connected to microstrip line 1406c, and the two output terminals are connected to copper foil pattern 1408c and microstrip line 1410c. Copper foil pattern 1408c is grounded to grounding conductor 1102 via through-hole 1409c. Copper foil patterns 1408a through 1408c and microstrip lines 1410a through 1410c are copper foil patterns formed on the −Z side of dielectric substrate 1101.

Similarly, switches 1412a through 1412c are also SPDT (Single Pole Double Throw) switches having one input terminal and two output terminals. In switches 1412a through 1412c, the input terminal is respectively connected to microstrip line 1411a, 1411b and 1411c, and the two output terminals are respectively connected to copper foil pattern 1413a and a microstrip line 1415a, copper foil pattern 1413b and microstrip line 1415b, and copper foil pattern 1413c and microstrip line 1415c. Copper foil patterns 1413a through 1413c are grounded to grounding conductor 1102 via through-holes 1414a through 1414c. Copper foil patterns 1413a through 1413c and microstrip lines 1415a through 1415c are copper foil patterns formed on the −Z side of dielectric substrate 1101.

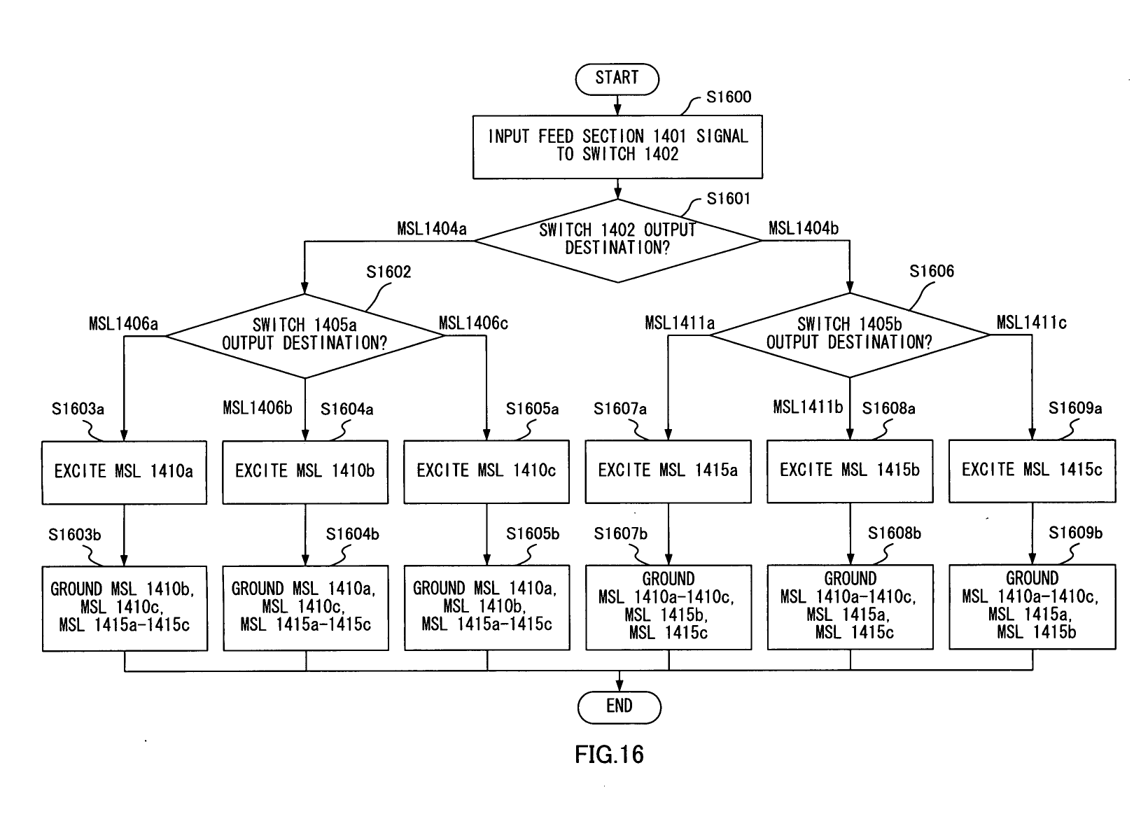

Power feeding to the antenna apparatus accompanying the switching circuit operation in the antenna apparatus configured as described above will now be explained using the flowchart in FIG. 16.

First, a signal of feed point 1401 is inputted to switch 1402 (S1600). Then the output destination of switch 1402 is determined (S1601). If the output terminal of switch 1402 is connected to microstrip line 1404a, the processing flow proceeds to S1602. In S1602, the output destination of switch 1405a is determined. If the output terminal of switch 1405a is connected to microstrip line 1406a, microstrip line 1410a is excited (S1603a). At this time, microstrip lines 1410b, 1410c, and 1415a through 1415c are simultaneously grounded via through-holes (S1603b). In this way, by exciting the junction of slot elements 1103a and 1103b by means of microstrip line 1410a, the antenna apparatus can be fed.

Alternatively, if the output terminal of switch 1405a is connected to microstrip line 1406b, microstrip line 1410b is excited (S1604a). At this time, microstrip lines 1410a, 1410c, and 1415a through 1415c are simultaneously grounded via through-holes (S1604b). In this way, by exciting the junction of slot elements 1104a and 1104b by means of microstrip line 1410b, the antenna apparatus can be fed.

Alternatively, if the output terminal of switch 1405a is connected to microstrip line 1406c, microstrip line 1410c is excited (S1605a). At this time, simultaneously, microstrip lines 1410a, 1410b, and 1415a through 1415c are grounded via through-holes (S1605b). In this way, by exciting the junction of slot elements 1105a and 1105b by means of microstrip line 1410c, the antenna apparatus can be fed.

Next, the case where the output terminal of switch 1402 is connected to microstrip line 1404b will be considered. In S1606, the output destination of switch 1405b is determined. If the output terminal of switch 1405b is connected to microstrip line 1411a, microstrip line 1415a is excited (S1607a). At this time, simultaneously, microstrip lines 1410a through 1410c, 1415b, and 1415c are grounded via through-holes (S1607b). In this way, by exciting the junction of slot elements 1103c and 1103d by means of microstrip line 1415a, the antenna apparatus can be fed.

Alternatively, if the output terminal of switch 1405b is connected to microstrip line 1411b, microstrip line 1415b is excited (S1608a). At this time, simultaneously, microstrip lines 1410a through 1410c, 1415a, and 1415c are grounded via through-holes (S1608b). In this way, by exciting the junction of slot elements 1104c and 1104d by means of microstrip line 1415b, the antenna apparatus can be fed.

Alternatively, if the output terminal of switch 1405b is connected to microstrip line 1411c, microstrip line 1415c is excited (S1609a). At this time, simultaneously, microstrip lines 1410a through 1410c, 1415a, and 1415b are grounded via through-holes (S1609b). In this way, by exciting the junction of slot elements 1105c and 1105d by means of microstrip line 1415c, the antenna apparatus can be fed.

Thus, according to this embodiment, it is possible to switch the main beam direction in the vertical plane and conical plane with a feed switching configuration implemented by means of switching circuits and microstrip lines.

### Embodiment 6

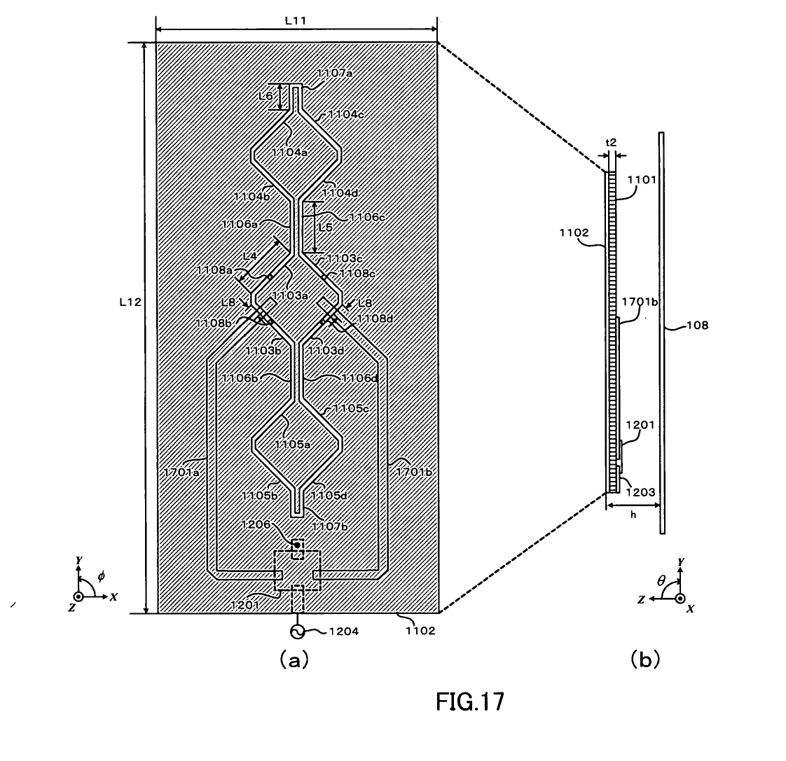

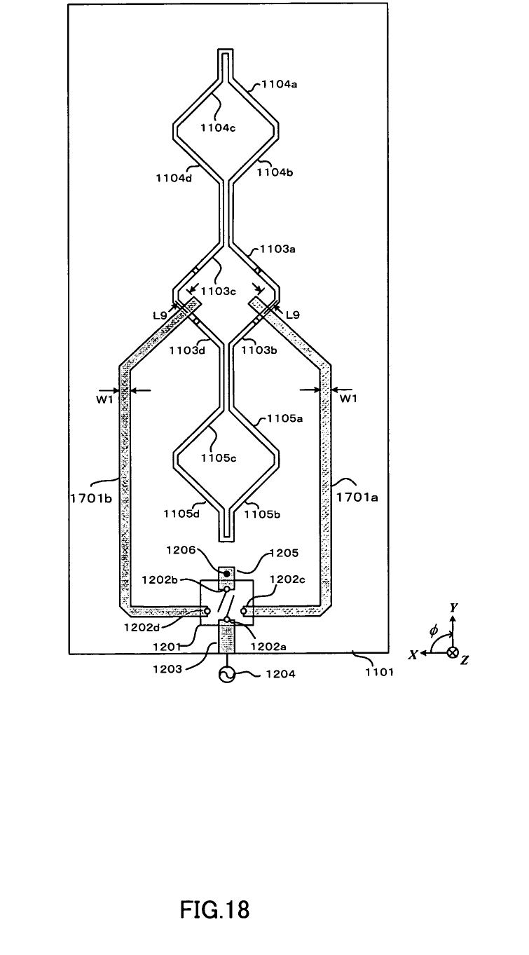

FIG. 17 and FIG. 18 are drawings showing the configuration of an antenna apparatus according to Embodiment 6 of the present invention. FIG. 17(a) is a planar view showing the antenna apparatus viewed from the +Z side, and FIG. 17(b) is an arrow view showing the antenna apparatus viewed from the +X side. FIG. 18 is a planar view of the antenna apparatus viewed from the −Z side, excluding plate reflector 108. In FIG. 17 and FIG. 18, parts common to FIG. 1, FIG. 11 and FIG. 12 are assigned the same reference numerals as in FIG. 1, FIG. 11 and FIG. 12 without further explanations. In the following description, the operating frequency is assumed to be 25 GHz. The coordinate axes shown in FIG. 17 and FIG. 18 are defined for convenience of explanation.

In this embodiment, a case is described in which the antenna apparatus excitation positions are shifted by L8 from the slot element junction in above described Embodiment 4. Here, one wavelength (one effective wavelength) is 7.2 mm, and L8 is approximately 0.18 wavelength.

Feed point 1204 is connected to input terminal 1202a via microstrip line 1203, and input terminal 1202b is connected to copper foil pattern 1205, and is grounded to copper foil layer 1102 which is a grounding conductor via through-hole 1206. Also, microstrip line 1701a is connected to output terminal 1202c, and a microstrip line 1701b is connected to output terminal 1202d. Above described microstrip line 1203 and copper foil pattern 1205 are copper foil patterns formed on the −Z side of dielectric substrate 1101.

Microstrip line 1701a is formed by means of a copper foil pattern on the −Z side of dielectric substrate 1101, with one end arranged so as to pass through slot element 1103b, and the other end connected to output terminal 1202c of switch 1201. Similarly, microstrip line 1701b is formed by means of a copper foil pattern on the −Z side of dielectric substrate 1101, with one end arranged so as to pass through slot element 1103d, and the other end connected to output terminal 1202d of switch 1201. Although not shown here, one end of microstrip line 1701a may be arranged so as to pass through slot element 1103a, and one end of microstrip line 1701b may be arranged so as to pass through slot element 1103c.

Width W1 of microstrip lines 1701a and 1701b is set to 0.6 mm so that the characteristic impedance is 50Ω. Distance L9 from the end of microstrip line 1701a to slot element 1103b, and distance L9 from the end of microstrip line 1701b to slot element 1103d, are set to 1.8 mm.

The operation in an antenna apparatus with the above described configuration when the antenna apparatus is excited from microstrip line 1701a will now be explained. A signal excited from feed point 1204 is inputted to input terminal 1202a of switch 1201. At this time, switch 1201 operates so that input terminal 1202a and output terminal 1202c, and input terminal 1202b and output terminal 1202d, are connected. Thus, the signal inputted to input terminal 1202a is inputted to microstrip line 1701a via output terminal 1202c.

On the other hand, microstrip line 1701b is grounded via input terminal 1202b and output terminal 1202d. Since the antenna elements are configured with slot elements, if magnetic fields are considered to be substituted for the electrical fields in the case of linear elements, it is necessary to create an open state at the junction of microstrip line 1701b and a slot element, that is, to ground the other end of microstrip line 1701b. Therefore, the length from the junction of microstrip line 1701b and a slot element to the grounding point—that is, the overall electrical length of microstrip line 1701b, copper foil pattern 1205, through-hole 1206, and switch 1201—must be set to an odd multiple of ¼ wavelength. By this means, it is possible to achieve high directional gain and a good F/B ratio.

Similarly, when the antenna apparatus is excited from microstrip line 1701b, switch 1201 operates so that input terminal 1202a and output terminal 1202d, and input terminal 1202b and output terminal 1202c, are connected. At this time, it is necessary to create an open state at the junction of microstrip line 1701a and a slot element, and therefore the length from the junction of microstrip line 1701a and the slot element to the grounding point must be set to an odd multiple of ¼ wavelength.

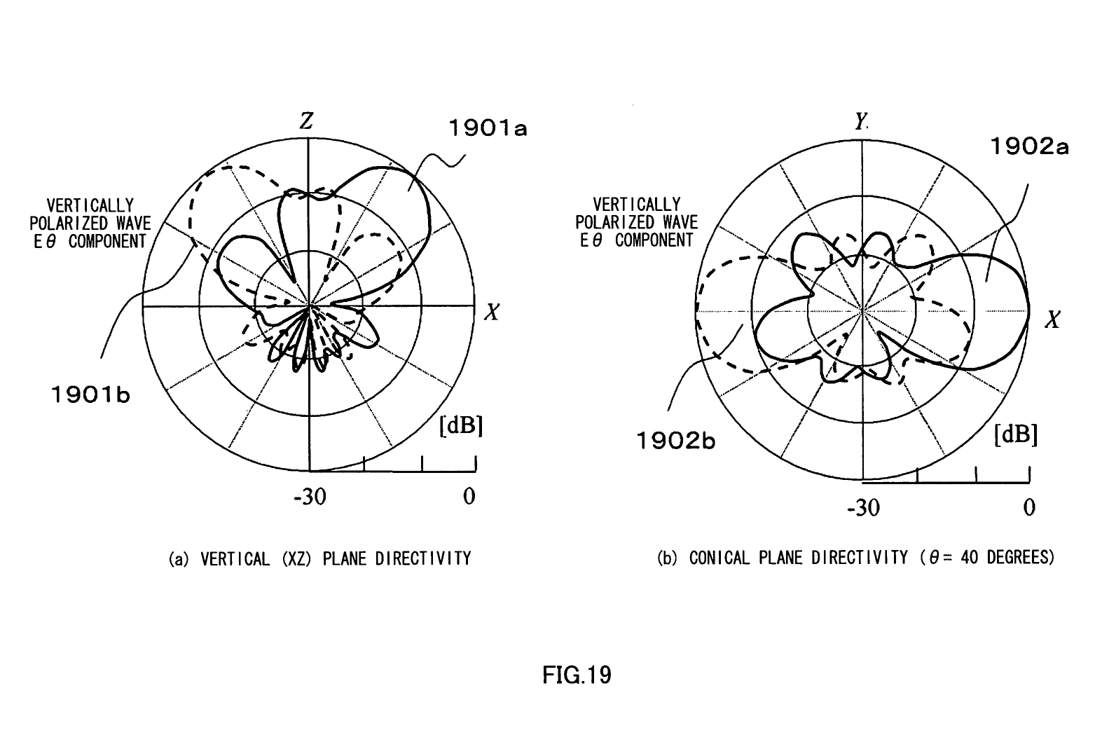

FIG. 19 is a drawing showing the directivity of an antenna apparatus according to Embodiment 6 of the present invention. FIG. 19(a) shows the directivity of the vertical (XZ) plane, and FIG. 19(b) shows the conical plane directivity with elevation angle θ of 40 degrees.

In FIG. 19(a), directivity 1901a indicated by a solid line shows the directivity of a vertically polarized wave (Eθ) component when the antenna apparatus is excited from microstrip line 1701a, and it can be confirmed that a main beam tilted in a direction in which elevation angle θ is 40 degrees is obtained. Directivity 1901b indicated by a dotted line shows the directivity of a vertically polarized wave (Eθ) component when the antenna apparatus is excited from microstrip line 1701b, and it can be confirmed that a main beam tilted in a direction in which elevation angle θ is 40 degrees is obtained.

In FIG. 19(b), directivity 1902a indicated by a solid line shows the directivity of a vertically polarized wave (Eθ) component when the antenna apparatus is excited from microstrip line 1701a, as in the case of directivity 1901a in FIG. 19(a), and it can be confirmed that the main beam is directed toward the +X direction. Directivity 902b indicated by a dotted line shows the directivity of a vertically polarized wave (Eθ) component when the antenna apparatus is excited from microstrip line 1701b, as in the case of directivity 1901b in FIG. 19(a), and it can be confirmed that the main beam is directed toward the −X direction. At this time, for both directivity 1902a and directivity 1902b, the main beam directional gain is 13.54 dBi, the conical plane half-power beam width is 30 degrees, and the F/B ratio is 13 dB.

Thus, according to this embodiment, it is possible to implement an antenna apparatus in which impedance matching and power feeding are simplified using microstrip lines, even with a configuration in which excitation is performed on slot elements between connecting conductors. Furthermore, it is possible to switch the main beam in two directions by switching power feeding to the microstrip lines using a switching circuit.

In this embodiment, slot elements are formed by means of copper foil patterns on a dielectric substrate, but a similar effect can also be obtained if slot elements are formed, for example, by providing voids in a conductive plate.

In this embodiment, connecting conductors have been described as being formed as copper foil patterns within slot elements, and connecting the inner copper foil layer and outer copper foil layer within slot elements so that the slot elements are divided approximately at their center, but a similar effect can also be obtained if connecting conductors are formed in the same plane as the microstrip lines, and connect the inner copper foil layer and outer copper foil layer via a through-hole.

In this embodiment, a configuration has been described in which connecting conductors are provided only in the center rhombic slot antenna section, but connecting conductors may also be provided in the rhombic slot antenna sections at both ends.

In this embodiment, a configuration has been described in which connecting conductors are provided only in the center rhombic slot antenna section, but connecting conductors may also be provided in a plurality of rhombic slot antenna sections.

In this embodiment, a case has been described in which a single DPDT switch is used as a switch, but a plurality of switches may also be used, as in a configuration, for example, using three SPDT (Single Pole Double Throw) switches.

In this embodiment, a case has been described in which one terminal of a switch is grounded, and the length from the junction of a microstrip line and slot element to the grounding point is made an odd multiple of ¼ wavelength, but high directional gain and a good F/B ratio can also be achieved with a configuration in which, for example, one terminal of the switch is left open, and the length from the junction of a microstrip line and slot element to the grounding point is made an integral multiple of ½ wavelength.

In this embodiment, a configuration has been described in which power is fed only to the center rhombic slot antenna section, but a configuration may also be used in which power is fed to the rhombic slot antenna sections at both ends.

In the above embodiments, cases have been described in which detour elements of a 3-element detour element loaded loop antenna are connected, but any number of elements may be used if within the scope of the above-described operating principles.

In the above embodiments, cases have been described in which rhombic antenna elements are connected, but “rhombic” here is used as a generic term for shapes including quadrilaterals, squares, parallelograms and trapezoids, and also including curved or round shapes. Therefore, a similar effect can also be obtained with, for example, circular antenna elements as one example of a round shape.

In the above embodiments, the length of linear elements and slot elements has been described as approximately ⅓ wavelength, but the directional gain and F/B ratio can be varied by varying the length of linear elements and slot elements. It is therefore preferable that the length of linear elements and slot elements is selected within a range of approximately ¼ wavelength to approximately ⅜ wavelength in order to achieve high directional gain and a good F/B ratio.

In the above embodiments, a case is assumed in which an antenna apparatus of the present invention is applied to an antenna for use in road-to-vehicle communication or vehicle-to-vehicle communication, but the present invention is not limited to such use.

An antenna apparatus of the present invention has the features described below. Firstly, an antenna apparatus adopts a configuration having a plurality of rhombic antenna sections in which four linear elements having lengths of approximately ¼ of the wavelength to approximately ⅜ of the wavelength of the used frequency are arranged in a rhombic shape in the same plane, and of the four linear elements, a first linear element and second linear element are connected and a third linear element and fourth linear element are connected, wherein the plurality of rhombic antenna sections are connected by a linear linking element having a predetermined length, a folded-back linear detour element having a predetermined full length is connected to each end of the linked plurality of rhombic antenna sections, a plate reflector is arranged at a predetermined distance from a plane in which the plurality of rhombic elements are arranged, and approximately parallel to that plane, the antenna apparatus having a first feed point that feeds power to the junction of the first linear element and second linear element out of one or another of the plurality of rhombic antenna sections, a second feed point that feeds power to a junction of the third linear element and fourth linear element, and a switching section that switches selectively between the first feed point and second feed point.

According to this configuration, it is possible to achieve high gain with a small, planar antenna apparatus. Also, by switching selectively between the first feed point and second feed point, it is possible to switch the main beam in two directions. Furthermore, it is possible to vary the angle of the main beam in the horizontal direction.

Secondly, the antenna apparatus adopts a configuration, further having a plurality of first feed points that feed power to the junction of a first linear element and second linear element of a plurality of rhombic antenna sections, a plurality of second feed points that feed power to a junction of a third linear element and fourth linear element, and a switching section that switches selectively between the plurality of first feed points and second feed points.

According to this configuration, it is possible to achieve high gain with a small, planar antenna apparatus. Also, by switching selectively between the plurality of first feed points and second feed points, it is possible to switch the main beam in two directions, and also to switch the angle of the main beam in the horizontal direction.

Thirdly, the antenna apparatus adopts a configuration further having a dielectric substrate that has a predetermined dielectric constant, and a conductive layer that is formed on a surface of the dielectric substrate, wherein, on the conductive layer, a plurality of rhombic slot antenna sections are provided in which four slot elements having lengths of approximately ¼ of the wavelength to approximately ⅜ of the wavelength of the used frequency are arranged in a rhombic shape, and out of the four slot elements, a first slot element and second slot element are connected and a third slot element and fourth slot element are connected, the plurality of rhombic slot antenna sections are connected by a slot linking element having a predetermined length, a folded-back slot detour element having a predetermined full length is connected to each end of the linked plurality of rhombic slot antenna sections, and a plate reflector is arranged at a predetermined distance from the surface of the dielectric substrate, and approximately parallel to the surface of the dielectric substrate, the antenna apparatus having a first feed point that feeds power to the junction of the first slot element and second slot element out of one or another of the plurality of rhombic slot antenna sections, a second feed point that feeds power to a junction of the third slot element and fourth slot element, and a switching section that switches selectively between the first feed point and second feed point.

According to this configuration, it is possible to achieve high gain with a small, planar antenna apparatus. Also, by switching selectively between the plurality of first feed points and second feed points, it is possible to switch the main beam in two directions.

Fourthly, the antenna apparatus adopts a configuration having a plurality of first feed points that feed power to the junction of a first slot element and second slot element of a plurality of rhombic slot antenna sections, a plurality of second feed points that feed power to a junction of a third slot element and fourth slot element, and a switching section that switches selectively between the plurality of first feed points and second feed points.

According to this configuration, by switching selectively between the plurality of first feed points and second feed points, it is possible to switch the main beam in two directions, and also to switch the angle of the main beam in the horizontal direction.

Fifthly, the antenna apparatus adopts a configuration, wherein a microstrip line provided on the rear surface of the surface on which the conductive layer of the dielectric substrate described in the third and fourth configurations is formed is used as a feed point.

According to this configuration, it is possible to achieve impedance matching by adjusting the length of the microstrip line, readily feed power to the antenna apparatus, and make the antenna apparatus smaller.

Sixthly, the antenna apparatus adopts a configuration, wherein a microstrip line has a switching section that switches between shorting and power feeding at a position of an odd multiple of approximately ¼ wavelength from a junction with a rhombic slot antenna section described in the third and fourth configurations.

According to this configuration, it is possible to implement an antenna apparatus with high directional gain and a good F/B ratio.

Seventhly, the antenna apparatus adopts a configuration, wherein the microstrip line has a switching section that switches between opening and power feeding at a position of an integral multiple of approximately ½ wavelength from a junction with a rhombic slot antenna section described in the third and fourth configurations.

According to this configuration, it is possible to implement an antenna apparatus with high directional gain and a good F/B ratio.

Eighthly, the antenna apparatus adopts a configuration, wherein, in at least one of a plurality of rhombic slot antenna sections, the inner conductive layer and outer conductive layer enclosed by the rhombic slot antenna sections are connected by means of a conductor formed as a copper foil pattern approximately in the center of the four slot elements.

According to this configuration, it is possible to implement an antenna apparatus in which impedance matching is easily achieved and F/B ratio is good.

Ninthly, the antenna apparatus adopts a configuration further having, in at least one of a plurality of rhombic slot antenna sections, a third feed point that feeds power on a slot element between conductors of a first slot element and second slot element to which a conductor is connected instead of a first feed point, a fourth feed point that feeds power on a slot element between conductors of a third slot element and fourth slot element to which a conductor is connected instead of a second feed point, and a switching section that switches selectively between the third feed point and fourth feed point.

According to this configuration, it is possible to implement an antenna apparatus in which impedance matching is easily achieved and that has a good F/B ratio.

As a more specific mode, an above described rhombic antenna section or above described rhombic slot antenna section is an antenna section or slot antenna section of rectangular shape including a quadrilateral, square, parallelogram and trapezoid, or of round shape including a curved and circular shape.

The present application is based on Japanese Patent Application No. 2004-345379 filed on Nov. 30, 2004, the entire content of which is expressly incorporated herein by reference.

### INDUSTRIAL APPLICABILITY

An antenna apparatus according to the present invention can achieve high gain with a small, planar configuration, and is useful when applied as an antenna in a system in which beam switching is effective such as an antenna for a road-to-vehicle or vehicle-to-vehicle communication, for example.

1. An antenna apparatus comprising a plurality of rhombic antenna sections in which four linear elements having lengths of approximately ¼ of a wavelength to approximately ⅜ of a wavelength of a used frequency are arranged in a rhombic shape in a same plane, and of the four linear elements, a first linear element and second linear element are connected, and a third linear element and fourth linear element are connected, wherein:
said plurality of rhombic antenna sections are connected by a linear linking element having a predetermined length;
a folded-back linear detour element having a predetermined full length is connected to each end of the linked plurality of rhombic antenna sections; and
a plate reflector is arranged at a predetermined distance from the plane in which the plurality of rhombic elements are arranged, and approximately parallel to the plane, said antenna apparatus comprising:
a first feed point that feeds power to a junction of said first linear element and said second linear element of one of said plurality of rhombic antenna sections;
a second feed point that feeds power to a junction of said third linear element and said fourth linear element; and
a switching section that switches selectively between said first feed point and said second feed point.

2. The antenna apparatus according to claim 1, further comprising:
a plurality of first feed points that feed power to a junction of said first linear element and said second linear element of said plurality of rhombic antenna sections;
a plurality of second feed points that feed power to a junction of said third linear element and said fourth linear element; and
a switching section that switches selectively between said plurality of first feed points and second feed points.

3. An antenna apparatus comprising
a dielectric substrate that has a predetermined dielectric constant; and
a conductive layer that is formed on a surface of said dielectric substrate, wherein:
on said conductive layer, a plurality of rhombic slot antenna sections are provided in which four slot elements having lengths of approximately ¼ of a wavelength to approximately ⅜ of a wavelength of a used frequency are arranged in a rhombic shape, and of the four slot elements, a first slot element and second slot element are connected, and a third slot element and fourth slot element are connected;
said plurality of rhombic slot antenna sections are connected by a slot linking element having a predetermined length;
a folded-back slot detour element having a predetermined full length is connected to each end of the linked plurality of rhombic slot antenna sections; and
a plate reflector is arranged at a predetermined distance from the surface of said dielectric substrate, and approximately parallel to the surface of said dielectric substrate, said antenna apparatus comprising:
a first feed point that feeds power to a junction of said first slot element and said second slot element of one of said plurality of rhombic slot antenna sections;
a second feed point that feeds power to a junction of said third slot element and said fourth slot element; and
a switching section that switches selectively between said first feed point and second feed point.

4. The antenna apparatus according to claim 3, further comprising:
a plurality of first feed points that feed power to a junction of said first slot element and said second slot element of said plurality of rhombic slot antenna sections;
a plurality of second feed points that feed power to a junction of said third slot element and said fourth slot element; and
a switching section that switches selectively between said plurality of first feed points and second feed points.

5. The antenna apparatus according to claim 3, wherein a microstrip line provided on a rear surface of a surface on which said conductive layer of said dielectric substrate is formed is used as the feed point.

6. The antenna apparatus according to claim 3, wherein said microstrip line comprises a switching section that switches between shorting and power feeding at a position of an odd multiple of approximately ¼ wavelength from a junction with said rhombic slot antenna section.

7. The antenna apparatus according to claim 3, wherein said microstrip line comprises a switching section that switches between opening and power feeding at a position of an integral multiple of approximately ½ wavelength from a junction with said rhombic slot antenna section.

8. The antenna apparatus according to claim 3, wherein, in at least one of said plurality of rhombic slot antenna sections, an inner conductive layer and outer conductive layer enclosed by said rhombic slot antenna sections are connected by means of a conductor formed as a copper foil pattern approximately in a center of said four slot elements.

9. The antenna apparatus according to claim 3, in at least one of said plurality of rhombic slot antenna sections, further comprising:
a third feed point that feeds power on a slot element between conductors of said first slot element and said second slot element to which a conductor is connected instead of said first feed point;
a fourth feed point that feeds power on a slot element between conductors of said third slot element and said fourth slot element to which a conductor is connected instead of said second feed point; and
a switching section that switches selectively between said third feed point and fourth feed point.

10. The antenna apparatus according to claim 1, wherein the rhombic antenna section is a square, quadrilateral, parallelogrammatic, trapezoidal, curved or circular antenna section.

11. The antenna apparatus according to claim 3, wherein the rhombic slot antenna section is a square, quadrilateral, parallelogrammatic, trapezoidal, curved or circular slot antenna section.
